(19) United States
(12) Patent Application Publication
(10) Pub. No.: US 2025/0133223 A1
(43) Pub. Date: Apr. 24, 2025

(54) Method and Apparatus for Image Encoding and Decoding

(71) Applicant: Huawei Technologies Co., Ltd., Shenzhen (CN)

(72) Inventors: Georgii Petrovich Gaikov, Moscow (RU); Sergey Yurievich Ikonin, Moscow (RU)

(21) Appl. No.: 19/005,272

(22) Filed: Dec. 30, 2024

Related U.S. Application Data
(63) Continuation of application No. PCT/RU2022/000209, filed on Jun. 30, 2022.

(51) Int. Cl. H04N 19/196; H04N 19/124; H04N 19/136; H04N 19/186; H04N 19/70

(52) U.S. Cl. CPC H04N 19/196; H04N 19/124; H04N 19/136; H04N 19/186; H04N 19/70

(57) ABSTRACT

In an image coding method, a first coding parameter is used to control image compression quality when encoding an image. A value of the first coding parameter is smaller than a preset minimal value or larger than a preset maximal value. A target gain vector is obtained based on the first coding parameter, and then the target gain vector is used to encode the image to obtain a bitstream. The first coding parameter is signaled in the bitstream and transmitted to the decoding side so that the bitstream can be correctly decoded. The method uses flexible setting of compression quality and bitstream size without training new coding models.

### CROSS-REFERENCE TO RELATED APPLICATIONS

This is a continuation of International Patent Application No. PCT/RU2022/000209, filed on Jun. 30, 2022, the disclosure of which is hereby incorporated by reference in its entirety.

### TECHNICAL FIELD

Embodiments of the present disclosure generally relate to the field of encoding and decoding data based on a neural network architecture. In particular, some embodiments relate to methods and apparatuses for such encoding and decoding images and/or videos from a bitstream using a plurality of processing layers.

### BACKGROUND

Hybrid image and video codecs have been used for decades to compress image and video data. In such codecs, a signal is typically encoded block-wise by predicting a block and by further coding only the difference between the original bock and its prediction. In particular, such coding may include transformation, quantization and generating the bitstream, usually including some entropy coding. Typically, the three components of hybrid coding methods-transformation, quantization, and entropy coding—are separately optimized. Modern video compression standards like High-Efficiency Video Coding (HEVC), Versatile Video Coding (VVC), and Essential Video Coding (EVC) also use a transformed representation to code residual signal after prediction.

Neural network (NN) architectures have been applied to image and/or video coding. In general, these NN-based approaches can be applied in various different ways to the image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approaches have also been discussed for usage in hybrid image and video coding frameworks, e.g. for implementation as a trained deep learning model for intra or inter prediction in image or video coding.

The end-to-end optimized image or video coding applications discussed above have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. Such corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud, or between different devices, a feature map at the output of the place of splitting (e.g. a first device) is compressed and transmitted to the remaining layers of the neural network (e.g. to a second device).

A model may be trained for a desired compression quality or a bitstream size. If different compression qualities are required, new models need to be trained, which needs a lot of time and computation cost. Additionally, the amount of storage required increases with the number of models.

Further improvement of encoding and decoding using trained network architectures may be desirable.

### SUMMARY

The present disclosure provides methods and apparatus to improve the flexibility of pre-trained image or video coding models. Therefore storing and transmitting cost for encoded images or videos are reduced without sacrificing image quality, or distortion of reconstructed images is reduced without more bits.

The foregoing and other objects are achieved by the subject matter of the claims. Further implementation forms are apparent from the description and the figures.

Example embodiments are outlined in the attached independent claims, with other embodiments in the dependent claims.

According to a first aspect, the present disclosure relates to a method for image encoding using a neural network. The method may be performed by an encoding device. The method includes obtaining an image, obtaining a first coding parameter for the image, wherein a value of the first coding parameter is smaller than a preset minimal value or larger than a preset maximal value, obtaining a target gain vector based on the first coding parameter and encoding the image based on the target gain vector. The first coding parameter (denoted as β) is used to select compression quality. The larger β, the larger bitstream size and better quality of reconstructed data.

Such method may provide more flexibility to pre-trained encoding models, as it enables to encode images with any desired compression quality or bitstream size without training new encoding models, especially when the compression quality indicated by a first coding parameter is outside a pre-trained range. By using this method, the pre-trained model can be used to encode images with any desired quality, which can be flexibly deployed to various scenarios.

The foregoing and other embodiments can each optionally include one or more of the following features, alone or in combination.

In a possible implementation, the preset minimal value βₛ and the preset maximal value βₜ are stored on the encoding device. During training stage of the encoding models (e.g. encoder 101 in FIG. 3A), several values of β between [βₛ, βₜ] are input to the models and trained to get the corresponding gain vectors. Then, a pre-trained set of possible values of β and corresponding gain vectors is obtained and stored on both encoding device and decoding device. The preset minimal value βₛ is the lower boundary of the value range of β and the preset maximal value βₜ is the upper boundary of the value range of β.

In a possible implementation, when the value of the first coding parameter is smaller than the preset minimal value, the obtaining a target gain vector based on the first coding parameter comprises obtaining the target gain vector based on the first coding parameter, the preset minimal value and a first gain vector corresponding to the preset minimal value.

Such method enables encoding the image with a smaller bitstream size and a lower compression quality. This may satisfy coding requirements in poor communication network situations.

In a possible implementation, the preset minimal value and the first gain vector corresponding to the preset minimal value are stored on the encoding device or a remote device as a table.

In a possible implementation, the preset minimal value and its relationship to the first gain vector are stored on the encoding device or a remote device. The relationship may be in a form of a function or a network model.

In a possible implementation, the obtaining the target gain vector based on the first coding parameter, the preset minimal value and the first gain vector comprises obtaining a first ratio of the first coding parameter to the preset minimal value and obtaining the target gain vector based on the first ratio and the first gain vector.

In a possible implementation, the obtaining the target gain vector based on the first ratio and the first gain vector comprises multiplying the first ratio and the first gain vector to obtain the target gain vector. The multiplying may be an elementwise multiplication operation.

In a possible implementation, the target gain vector satisfies the following condition: mᵥ=mₛ*(βᵥ/βₛ)^{K}, wherein mᵥ is the target gain vector, βₛ is the preset minimal value, βᵥ is the first coding parameter, ms is the first gain vector corresponding to the preset minimal value, and K is a hyper parameter, which may have a preset value. A default value of K may be 1.

In a possible implementation, when the value of the first coding parameter is larger than a preset maximal value, obtaining a target gain vector based on the first coding parameter comprises obtaining the target gain vector based on the first coding parameter, the preset maximal value and a second gain vector corresponding to the preset maximal value.

Such method enables to encode the image with a higher compression quality. This may satisfy coding requirements for some high coding quality situations, such as coding high-definition movies or real-time transmission of sports events.

In a possible implementation, the preset maximal value and the second gain vector corresponding to the preset maximal value are stored on the encoding device or a remote device as a table.

In a possible implementation, the preset maximal value and its relationship to the second gain vector are stored on the encoding device or a remote device. The relationship may be in a form of a function or a network model.

In a possible implementation, the obtaining the target gain vector based on the first coding parameter, the preset maximal value and the second gain vector comprises obtaining a second ratio of the first coding parameter to the preset maximal value and obtaining the target gain vector based on the second ratio and the second gain vector.

In a possible implementation, the obtaining the target gain vector based on the second ratio and the second gain vector comprises multiplying the second ratio and the second gain vector to obtain the target gain vector. The multiplying may be an elementwise multiplication operation.

In a possible implementation, the target gain vector satisfies the following condition: mᵥ=mₜ*(βᵥ/βₜ)^{K}, wherein mᵥ is the target gain vector, βₜ is the preset maximal value, βᵥ is the first coding parameter, mₜ is the second gain vector corresponding to the preset maximal value, and K is a hyper parameter, the value of which may be preset. A default value of K may be 1. In a possible design, the value of K may depend on By.

In a possible implementation, when the value of the first coding parameter is smaller than the preset minimal value, the obtaining a target gain vector based on the first coding parameter comprises obtaining the target gain vector based on the first coding parameter, the preset minimal value, a first gain vector corresponding to the preset minimal value, a third preset value which is nearest to the preset minimal value, and a third gain vector corresponding to the third preset value. The third preset value is a pre-trained value which is nearest to the preset minimal value in the pre-trained set of several values of β.

Such method enables to encode the image with a smaller bitstream size and a relatively good compression quality by using two nearest preset values of the coding parameter and their corresponding gain vectors.

In a possible implementation, when the value of the first coding parameter is larger than a preset maximal value, the obtaining a target gain vector based on the first coding parameter comprises obtaining the target gain vector based on the first coding parameter, the preset maximal value, a second gain vector corresponding to the preset maximal value, a fourth preset value which is nearest to the preset maximal value, and a fourth gain vector corresponding to the fourth preset value. The fourth preset value is a pre-trained value which is nearest to the preset maximal value in the pre-trained set of several values of β.

Such method enables encoding the image with an even higher compression quality by using two nearest preset values of the coding parameter and their corresponding gain vectors.

In a possible implementation, the obtaining a target gain vector based on the first coding parameter comprises obtaining the target gain vector based on the first coding parameter, N preset values and N gain vectors corresponding to the N preset values, wherein N is an integer larger than 2, the N preset values include the preset minimal value and/or the preset maximal value.

Such method can provide even more coding performance by using more pre-trained values of β and their corresponding gain vectors.

In a possible implementation according to the first aspect and any one of its possible implementations, the encoding the image based on the target gain vector comprises obtaining a first feature map of the image using a neural network and obtaining a second feature map based on the first feature map and the target gain vector; quantizing the second feature map to obtain a quantized second feature map; and encoding the quantized second feature map to obtain a bitstream. For example, the quantized second feature map may be encoded using entropy encoding.

In a possible implementation, the obtaining a second feature map based on the first feature map and the target gain vector comprises multiplying the target gain vector with the first feature map. The multiplying may be an elementwise multiplication operation.

In a possible implementation, the first feature map is a tensor with a shape of w×h×d, the target gain vector is a vector with dimension 1×d, w and h represent the width and height of the first feature map, and d represents a number of channels of the first feature map. The gain vectors can be seen as part of model weights.

In a possible implementation, when the first feature map is a feature map of luma samples of the image, d equals to 128.

In a possible implementation, when the first feature map is a feature map of chroma samples of the image, d equals to 64.

In a possible implementation, wherein the method further comprises obtaining a second coding parameter for the image, and when the first coding parameter is used to encode luma samples of the image, the second coding parameter is used to encode chroma samples of the image, or when the first coding parameter is used to encode chroma samples of the image, the second coding parameter is used to encode luma samples of the image. At least one of the values of first coding parameter and the second coding parameter is smaller than a preset minimal value or larger than a preset maximal value.

In a possible implementation, the method further comprises encoding the first coding parameter into a bitstream. In a possible design, the first coding parameter is directly encoded into the bitstream. In another possible design, the first coding parameter is encoded into the bitstream as a first flag (e.g. base 2 logarithm of the first coding parameter) to save bits, wherein the first flag can be used to derive the first coding parameter.

In a possible implementation, the first coding parameter is encoded in picture parameter set (PPS) of the bitstream.

In a possible implementation, the number of bits used to signal the first coding parameter in the bitstream is less than or equal to 16. When a first flag is used to derive the first coding parameter, the bits used to signal the first coding parameter in the bitstream may even be reduced to less than or equal to 4.

In a possible implementation, the image comprises both luma samples and chroma samples, a second coding parameter is signaled in the bitstream as well, and when the first coding parameter is used to encode luma samples of the image, the second coding parameter is used to encode chroma samples of the image, or when the first coding parameter is used to encode chroma samples of the image, the second coding parameter is used to encode luma samples of the image. At least one of the values of first coding parameter and the second coding parameter is smaller than a preset minimal value or larger than a preset maximal value.

According to a second aspect, the present disclosure relates to a method for decoding a bitstream to obtain images. The method is performed by a decoding device. The method includes obtaining a bitstream comprising coded image data, parsing the bitstream to obtain a first coding parameter, wherein a value of the first coding parameter is smaller than a preset minimal value or larger than a preset maximal value, obtaining a target inverse gain vector based on the first coding parameter, and obtaining an image based on the target inverse gain vector.

Such method may provide more flexibility to pre-trained decoding models, as it enables to decode images with any desired compression quality or bitstream size without training new decoding models, especially when the compression quality indicated by a first coding parameter is outside a pre-trained range. By using this method, the pre-trained models can be used to encode or decode images with any desired quality, which can be flexibly deployed to various scenarios.

The foregoing and other embodiments can each optionally include one or more of the following features, alone or in combination.

In a possible implementation, the preset minimal value βₛ and the preset maximal value βₜ are stored on the decoding device. During training stage of the decoding models (e.g. decoder 104 in FIG. 3A), several values of β between [βₛ, βₜ] are input to the models and trained to get the corresponding gain vectors. Then, a pre-trained set of possible values of β and corresponding gain vectors is obtained and stored on both encoding device and decoding device. The preset minimal value βₛ is the lower boundary of the value range of β and the preset maximal value βₜ is the upper boundary of the value range of β.

In a possible implementation, when the value of the first coding parameter is smaller than the preset minimal value, the obtaining a target inverse gain vector based on the first coding parameter comprises obtaining the target inverse gain vector based on the first coding parameter, the preset minimal value and a first gain vector corresponding to the preset minimal value.

Such method enables to decode the image with a smaller bitstream size and a lower compression quality. This may satisfy coding requirements in poor communication network situations. By using this method, the pre-trained model can be used to encode or decode images with any desired quality, which can be flexibly deployed to various scenarios.

In a possible implementation, the preset minimal value and the first gain vector corresponding to the preset minimal value are stored on the decoding device or a remote device as a table.

In a possible implementation, the preset minimal value and its relationship to the first gain vector are stored on the decoding device or a remote device. The relationship may be in a form of a function or a network model.

In a possible implementation, the obtaining the target inverse gain vector based on the first coding parameter, the preset minimal value and the first gain vector comprises obtaining a first ratio of the first coding parameter to the preset minimal value obtaining the target inverse gain vector based on the first ratio and the first gain vector.

In a possible implementation, the obtaining the target inverse gain vector based on the first ratio and the first gain vector comprises multiplying the first ratio and the first gain vector to obtain a target gain vector and obtaining the target inverse gain vector based on the target gain vector.

In a possible implementation, wherein the target gain vector satisfies the following condition:

$${m}_{v} = {m}_{s} * {( \frac{{β}_{v}}{{β}_{s}} )}^{K}$$

wherein mᵥ is the target gain vector, βₛ is the preset minimal value, βᵥ is the first coding parameter, mₛ is the first gain vector corresponding to the preset minimal value, and K is a hyper parameter, the value of K may be preset. A default value of K may be 1.

In a possible implementation, the value of the first coding parameter is larger than a preset maximal value, wherein the obtaining a target inverse gain vector based on the first coding parameter comprises obtaining the target inverse gain vector based on the first coding parameter, the preset maximal value and a second gain vector corresponding to the preset maximal value.

Such method enables to decode the image which is encoded with an even higher compression quality by using two nearest preset values of the coding parameter and their corresponding gain vectors. By using this method, the pre-trained model can be used to encode or decode images with any desired quality, which can be flexibly deployed to various scenarios.

In a possible implementation, the obtaining the target inverse gain vector based on the first coding parameter, the preset maximal value and the second gain vector comprises obtaining a second ratio of the first coding parameter to the preset maximal value and obtaining the target inverse gain vector based on the second ratio and the second gain vector.

In a possible implementation, the obtaining the target inverse gain vector based on the second ratio and the second gain vector comprises multiplying the second ratio and the second gain vector to obtain a target gain vector and obtaining the target inverse gain vector based on the target gain vector.

In a possible implementation, the target gain vector satisfies the following condition:

$${m}_{v} = {m}_{t} * {( \frac{{β}_{v}}{{β}_{t}} )}^{K} ,$$

wherein mᵥ is the target gain vector, βₜ is the preset maximal value, βᵥ is the first coding parameter, mₜ is the second gain vector corresponding to the preset maximal value, and K is a hyper parameter, which may have a preset value. A default value of K may be 1.

In a possible implementation, the target inverse gain vector satisfies the following condition: mᵥ′*mᵥ=C, wherein mᵥ′ is the target inverse gain vector, mᵥ is the target gain vector, C is a vector whose elements are all constants, and * means elementwise multiplication operation. In a possible design, C is a constant, and * means dot multiplication operation.

In a possible implementation, the value of the first coding parameter is smaller than the preset minimal value, wherein the obtaining a target inverse gain vector based on the first coding parameter comprises obtaining the target inverse gain vector based on the first coding parameter, the preset minimal value and a first gain vector corresponding to the preset minimal value, a third preset value which is nearest to the preset minimal value and a third gain vector corresponding to the third preset value.

In a possible implementation, when the value of the first coding parameter is larger than a preset maximal value, the obtaining a target inverse gain vector based on the first coding parameter comprises obtaining the target inverse gain vector based on the first coding parameter, the preset maximal value and a second gain vector corresponding to the preset maximal value, a fourth preset value which is nearest to the preset maximal value and a fourth gain vector corresponding to the fourth preset value.

In a possible implementation, the obtaining a target inverse gain vector based on the first coding parameter comprises obtaining the target inverse gain vector based on the first coding parameter, N preset values and N gain vectors corresponding to the N preset values, wherein N is an integer larger than 2, the N preset values include the preset minimal value and/or the preset maximal value.

In a possible implementation, the decoding the bitstream to obtain an image based on the target inverse gain vector comprises parsing the bitstream to obtain a first latent representation of an image using entropy decoding; obtaining a second latent representation based on the first latent representation and the target inverse gain vector; decoding the second latent representation to obtain the image using a neural network.

In a possible implementation, the obtaining a second latent representation based on the first latent representation and the target inverse gain vector comprises multiplying the target inverse gain vector with the first latent representation. The multiplying may be elementwise multiplication operation.

In a possible implementation, the first latent representation is a tensor with a shape of w×h×d, the target inverse gain vector is a vector with dimension 1×d, w and h represent the width and height of the first feature map, and d represents a number of channels of the first feature map.

In a possible implementation, when the first latent representation is a feature map of luma samples of the image, d equals to 128.

In a possible implementation, when the first latent representation is a feature map of chroma samples of the image, d equals to 64.

In a possible implementation, the method further comprises parsing the bitstream to obtain a second coding parameter; and when the first coding parameter is used to decode luma samples of the image, the second coding parameter is used to decode chroma samples of the image; or when the first coding parameter is used to decode chroma samples of the image, the second coding parameter is used to decode luma samples of the image.

The proposed method allows to decode images with luma samples and chroma samples compressed in different qualities.

According to a third aspect, the present disclosure relates to an apparatus/device for decoding images or videos. Such apparatus for decoding may refer to the same advantageous effect as the method for decoding according to the second aspect. Details are not described herein again. The decoding apparatus provides technical means for implementing an action in the method defined according to the second aspect. The function may be implemented by hardware, or may be implemented by hardware executing corresponding software. In a possible implementation, the decoding apparatus/device includes an entropy decoding module configured to parse a bitstream to obtain a first latent representation of an image using entropy decoding, an inverse gain unit configured to obtain a second latent representation based on the first latent representation and a target inverse gain vector, and an image reconstructing module configured to decode the second latent representation to obtain the image using a neural network. These modules may be adapted to provide respective functions which correspond to the method example according to the second aspect. For details, it is referred to the detailed descriptions in the method example. Details are not described herein again.

In a possible implementation, the decoding device further comprises an inverse gain vector obtaining module configured to, obtain the target inverse gain vector based on a first coding parameter.

According to a fourth aspect, the present disclosure relates to an apparatus/device for encoding images or videos. Such apparatus for encoding may refer to the same advantageous effect as the method for encoding according to the first aspect. Details are not described herein again. The encoding apparatus provides technical means for implementing an action in the method defined according to the first aspect. The function may be implemented by hardware, or may be implemented by hardware executing corresponding software. In a possible implementation, the encoding apparatus includes a feature map obtaining module configured to obtain a first feature map from an input image, a gain unit configured to transform the first feature map based on a target gain vector to obtain a second feature map, a quantizing module configured to quantize the second feature map to obtain a quantized second feature map, and an entropy encoding module configured to encode the quantized second feature map to obtain a bitstream (for example, by using entropy encoding). These modules may be adapted to provide respective functions which correspond to the method example according to the first aspect. For details, it is referred to the detailed descriptions in the method example. Details are not described herein again.

In a possible implementation, the encoding device may further comprise a gain vector obtaining module configured to, obtain the target gain vector based on a first coding parameter.

The method according to the first aspect of the present disclosure may be performed by the apparatus according to the fourth aspect of the present disclosure n. Further features and implementations of the method according to the first aspect of the present disclosure correspond to respective features and implementations of the apparatus according to the fourth aspect of the present disclosure. The advantages of the method according to the first aspect can be the same as those for the corresponding implementation of the apparatus according to the fourth aspect.

The method according to the second aspect of the present disclosure may be performed by the apparatus according to the third aspect of the present disclosure. Further features and implementations of the method according to the second aspect of the present disclosure correspond to respective features and implementations of the apparatus according to the third aspect of the present disclosure. The advantages of the method according to the second aspect can be the same as those for the corresponding implementation of the apparatus according to the third aspect.

According to a fifth aspect, the present disclosure relates to a video stream or image decoding apparatus, including a processor and a memory. The memory stores instructions that cause the processor to perform the method according to the second aspect.

According to a sixth aspect, the present disclosure relates to a video stream or image encoding apparatus, including a processor and a memory. The memory stores instructions that cause the processor to perform the method according to the first aspect.

According to a seventh aspect, a computer-readable storage medium having stored thereon instructions that when executed cause one or more processors to encode video or image data is proposed. The instructions cause the one or more processors to perform the method according to the first or second aspect or any possible embodiment of the first or second aspect.

According to an eighth aspect, the present disclosure relates to a computer program product including program code for performing the method according to the first or second aspect or any possible embodiment of the first or second aspect when executed on a computer.

According to a ninth aspect, the present disclosure relates to a coder comprising processing circuitry for carrying out the method according to the first or second aspect or any possible embodiment of the first or second aspect.

According to a tenth aspect, the present disclosure relates to a storage medium, wherein the storage medium stores a bitstream obtained by using the method according to the first aspect or any possible embodiment of the first aspect.

According to an eleventh aspect, the present disclosure relates to a storage medium, wherein the storage medium stores a bitstream which can be decoded by using the method according to the second aspect or any possible embodiment of the second aspect.

According to a twelfth aspect, the present disclosure relates to an encoded bitstream by including coded image data and a plurality of syntax elements, wherein the plurality of syntax elements comprises a first flag (such as compression_quality_level), and wherein the first flag indicates a compression quality of the coded image data. The encoded bitstream may be obtained by performing method according to the first aspect or any possible embodiment of the first aspect of the present disclosure. The encoded bitstream can be decoded by performing method according to the second aspect or any possible embodiment of the second aspect of the present disclosure.

According to a thirteenth aspect, the present disclosure relates to an encoded bitstream by including coded image data and a plurality of syntax elements, wherein the plurality of syntax elements comprises a first flag (such as compression_quality_level_luma) and a second flag (such as compression_quality_level_chroma), wherein the first flag indicates a compression quality of luma samples of the coded image data and the second flag indicates a compression quality of chroma samples of the coded image data. The encoded bitstream may be obtained by performing method according to the first aspect or any possible embodiment of the first aspect of the present disclosure. The encoded bitstream can be decoded by performing method according to the second aspect or any possible embodiment of the second aspect of the present disclosure.

According to a fourteenth aspect, the present disclosure relates to a coding apparatus, comprising receiver units configured to receive a picture to encode or to receive a bitstream to decode, transmitter units coupled to the receiver units, the transmitter units configured to transmit the bitstream to a decoder or to transmit a decoded image to a display, a memory coupled to at least one of the receiver units or the transmitter units, the memory configured to store instructions, and a processor coupled to the memory, the processor configured to execute the instructions stored in the memory to perform the method according to the first or second aspect or any possible embodiment of the first or second aspect.

According to a fifteenth aspect, the present disclosure relates to a coding system, comprising: an encoder; and a decoder in communication with the encoder, wherein the encoder or the decoder includes the decoding device according to the third or fifth aspect of the present disclosure, the encoding device according to the fourth or sixth aspect of the present disclosure, or the coding apparatus according to the fourteenth aspect of the present disclosure.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the present disclosure are described in more detail with reference to the attached figures and drawings, in which

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A is a block diagram illustrating end-to-end video compression framework based on a neural networks;

FIG. 6B is a block diagram illustrating some exemplary details of application of a neural network for motion field compression;

FIG. 6C is a block diagram illustrating some exemplary details of application of a neural network for motion compensation;

FIG. 7 is a flow diagram illustrating an exemplary method for encoding;

FIG. 8 is a schematic drawing illustrating the relation of the first coding parameter and the gain vectors;

FIG. 9 is a flow chart of an exemplary method for encoding an image based on a target gain vector;

FIG. 10 is a schematic drawing illustrating an exemplary network architecture for encoder and decoder side including a gain unit;

FIG. 11 is a flow diagram illustrating an exemplary method for decoding;

FIG. 12 is a flow chart of an exemplary method for decoding a bitstream based on a target gain vector;

FIG. 13 is a block diagram showing an example of a video encoding device configured to implement encoding embodiments of the present disclosure;

FIG. 14 is a block diagram showing an example of a video decoding device configured to implement decoding embodiments of the present disclosure;

FIG. 15 is a block diagram showing an example of a video coding system configured to implement embodiments of the present disclosure;

FIG. 16 is a block diagram showing another example of a video coding system configured to implement embodiments of the present disclosure;

FIG. 17 is a block diagram illustrating an example of an encoding apparatus or a decoding apparatus; and

FIG. 18 is a block diagram illustrating another example of an encoding apparatus or a decoding apparatus.

Like reference numbers and designations in different drawings may indicate similar elements.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the specification, claims, and the accompanying drawings of this disclosure, the terms “first”, “second”, and the like are intended to distinguish between similar objects but do not necessarily indicate a specific order or sequence. It should be understood that the terms used in such a way are interchangeable in proper circumstances, which is merely a discrimination manner that is used when objects having a same attribute are described in the embodiments of this disclosure. In addition, the terms “include”, “have” and any other variants thereof mean to cover the non-exclusive inclusion, so that a process, method, system, product, or device that includes a series of units is not necessarily limited to those units, but may include other units not expressly listed or inherent to such a process, method, product, or device.

In the specification, claims, and the accompanying drawings of this disclosure, the term “and/or” is merely an association relationship for describing associated objects. The term “and/or” indicates that three relationships may exist. For example, A and/or B may represent three cases: only A exists, both A and B exist, and only B exists.

In the following, an overview over some of the used technical terms and framework within which the embodiments of the present disclosure may be employed is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The name “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

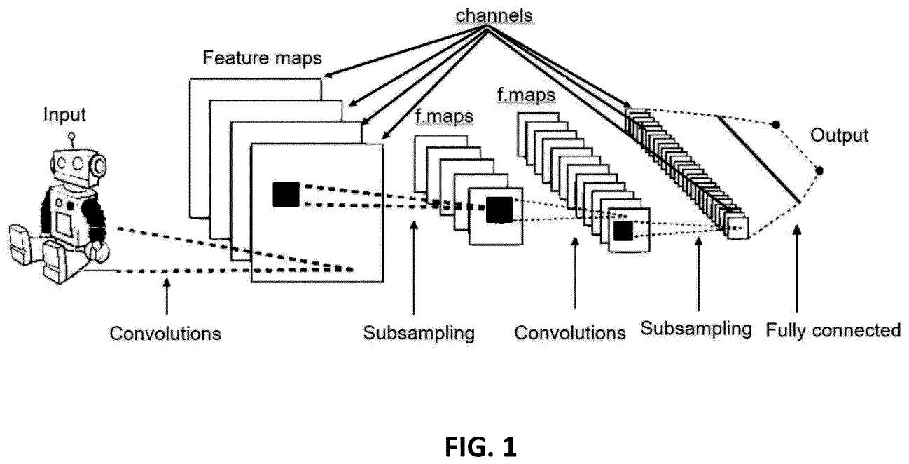

FIG. 1 schematically illustrates a general concept of processing by a neural network such as the CNN. A convolutional neural network consists of an input and an output layer, as well as multiple hidden layers. Input layer is the layer to which the input (such as a portion of an image as shown in FIG. 1) is provided for processing. The hidden layers of a CNN typically consist of a series of convolutional layers that convolve with a multiplication or other dot product. The result of a layer is one or more feature maps (f.maps in FIG. 1), sometimes also referred to as channels. There may be a subsampling involved in some or all of the layers. As a consequence, the feature maps may become smaller, as illustrated in FIG. 1. The activation function in a CNN is usually a ReLU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with a shape of (number of images)×(image width)×(image height)×(image depth). Should be known that image depth can be constitute of channels of image. After passing through a convolutional layer, the image becomes abstracted to a feature map, with a shape of (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with red-green-blue (RGB) color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear downsampling. There are several non-linear functions to implement pooling among which max pooling is the most common. It partitions the input image into a set of non-overlapping rectangles and for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favor compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function or the LeakyReLU. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or chroma-blue-red (YUV) representation of images or video, or 1 channel for grayscale image or video representation.

### Autoencoders and Unsupervised Learning

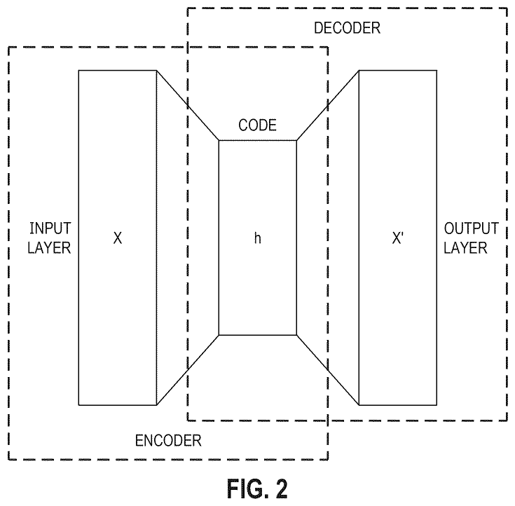

An autoencoder is a type of artificial neural network used to learn efficient data codings in an unsupervised manner. A schematic drawing thereof is shown in FIG. 2. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name. In the simplest case, given one hidden layer, the encoder stage of an autoencoder takes the input x and maps it to h, where h=σ(Wx+b).

This image h is usually referred to as code, latent variables, or latent representation. Here, σ is an element-wise activation function such as a sigmoid function or a rectified linear unit. W is a weight matrix and b is a bias vector. Weights and biases are usually initialized randomly, and then updated iteratively during training through Backpropagation. After that, the decoder stage of the autoencoder maps h to the reconstruction x′ of the same shape as x: x′=σ′(W′h′+b′) where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a variable auto-encoder (VAE) typically matches that of the training data much closer than a standard autoencoder. The objective of VAE has the following form:

$$ℒ ( ϕ , θ , x ) = {D}_{K L} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior values over the latent variables is usually set to be the centered isotropic multivariate Gaussian p_{θ}(h)=N(0, I). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I ) ,$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, end-to-end optimized image compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs, the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, Joint Photographic Experts Group (JPEG) uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. Several transforms are used for that purpose such as discrete cosine transforms (DCTs) and discrete sine transforms (DSTs), as well as low-frequency non-separable transforms (LFNSTs).

### Variational Image Compression

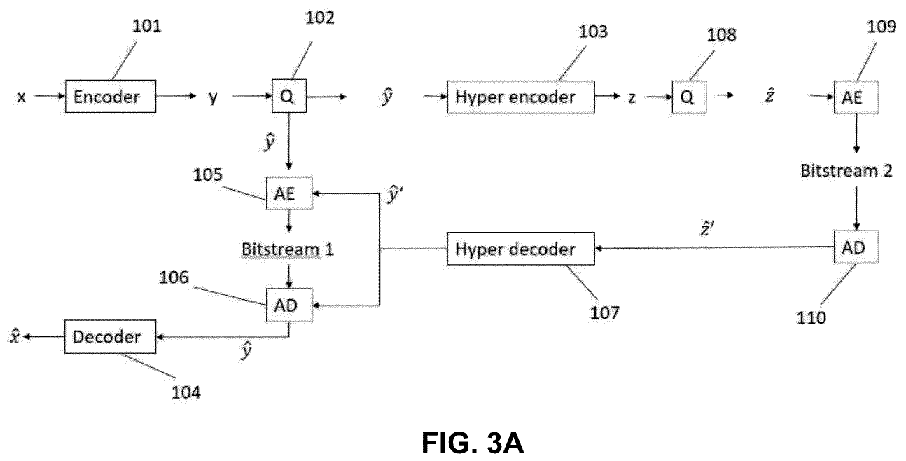

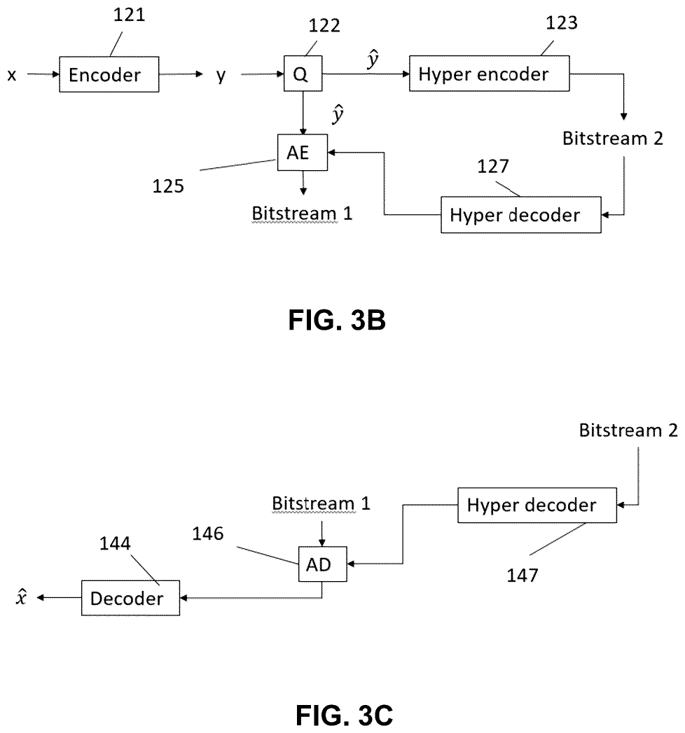

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream 1 and bitstream 2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream 1”. The second network in FIG. 3A comprises modules 103, 108, 109, 110 and 107 is called “hyper encoder/decoder” subnetwork. The second subnetwork is responsible for generating the second bitstream “bitstream 2”. The purposes of the two subnetworks are different.

The first subnetwork is responsible for: the transformation 101 of the input image x into its latent representation y (which is easier to compress that x), quantizing 102 the latent representation y into a quantized latent representation ŷ, compressing the quantized latent representation ŷ using the AE by the arithmetic encoding module 105 to obtain bitstream “bitstream 1”, parsing the bitstream 1 via AD using the arithmetic decoding module 106, and reconstructing 104 the reconstructed image (x) using the parsed data.

The purpose of the second subnetwork is to obtain statistical properties (e.g. mean value, variance and correlations between samples of bitstream 1) of the samples of “bitstream 1”, such that the compressing of bitstream 1 by first subnetwork is more efficient. The second subnetwork generates a second bitstream “bitstream 2”, which comprises the said information (e.g. mean value, variance and correlations between samples of bitstream 1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream 2. In this example, the binarization is performed by an arithmetic encoding (AE). A decoding part of the second network includes arithmetic decoding (AD) 110, which transforms the input bitstream 2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

FIG. 3A describes an example of VAE (variational auto encoder), details of which might be different in different implementations. For example in a possible implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream 1 and a bitstream 2. The bitstream 1 is the output of the first sub-network of the encoder and the bitstream 2 is the output of the second subnetwork of the encoder.

Similarly, in FIG. 3C, the two bitstreams, bitstream 1 and bitstream 2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for decoding, for example. It is noted that the components of the encoder and decoder denoted with numerals 12x and 14x may correspond in their function to the components referred to above in FIG. 3A and denoted with numerals 10x.

As is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream 2 already discussed above to the hyper decoder 147 that in turn provides the information to the arithmetic encoding module 105 (125).

The output of the arithmetic encoding module is the bitstream 1. The bitstream 1 and bitstream 2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of deep learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The authors optimize for mean squared error (MSE), but use a more flexible transforms built from cascades of linear convolutions and nonlinearities. Further, the authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

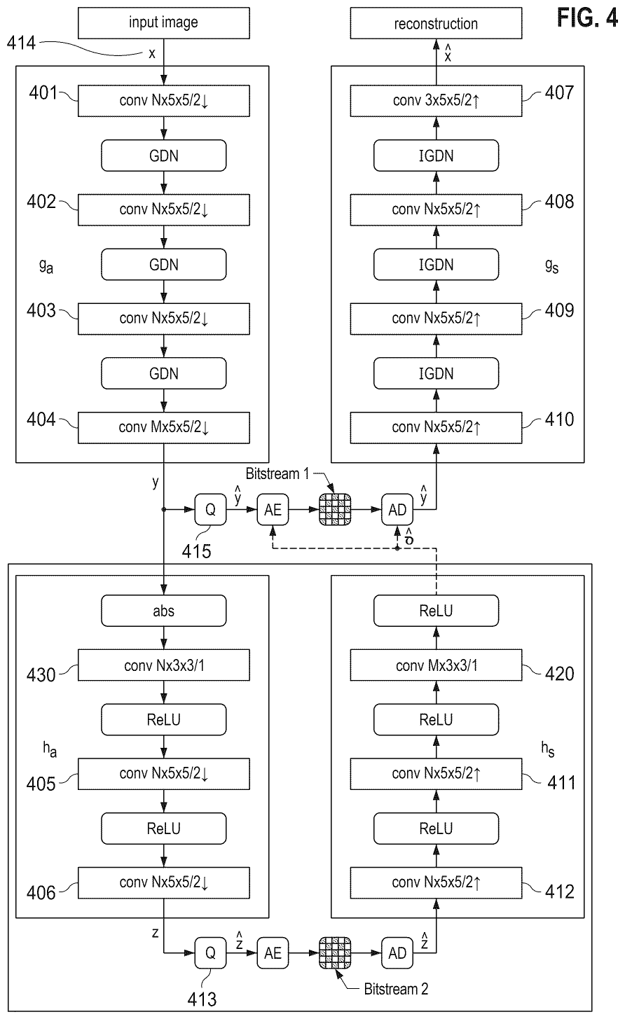

Such example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling is indicated with the downward arrow in the layer description. The layer description “Conv N×5×5/2↓” means that the layer is a convolution layer, with N channels and the convolution kernel is 5×5 in size. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6 downsampling layers, if the width and height of the input image 414 (also denoted with x) is given by w and h, the output signal z\hat{ }413 is has width and height equal to w/64 and h/64 respectively. Modules denoted by AE and AD are arithmetic encoder and arithmetic decoder, which are explained with reference to FIGS. 3A to 3C. The arithmetic encoder and decoder are implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream 2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). As they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

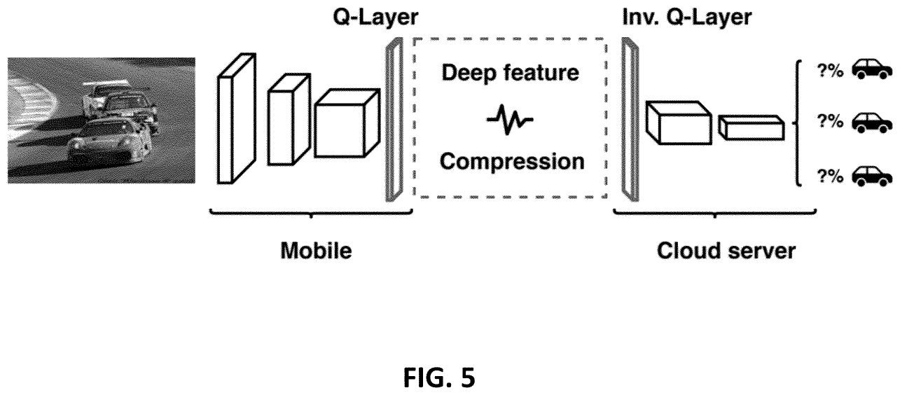

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile and the cloud, it is possible to distribute the computational workload such that the overall energy and/or latency of the system is minimized. In general, the collaborative intelligence is a paradigm where processing of a neural network is distributed between two or more different computation nodes for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways, from the cloud to the mobile during back-propagation in training, and from the mobile to the cloud during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part to the cloud an output of a hidden layer (a deep feature map), rather than sending compressed natural image data to the cloud and perform the object detection using reconstructed images. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and DCT, to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

Deep neural network (DNN) based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, authors proposed the end-to-end deep video compression (DVC) model that jointly learns motion estimation, motion compression, and residual coding.

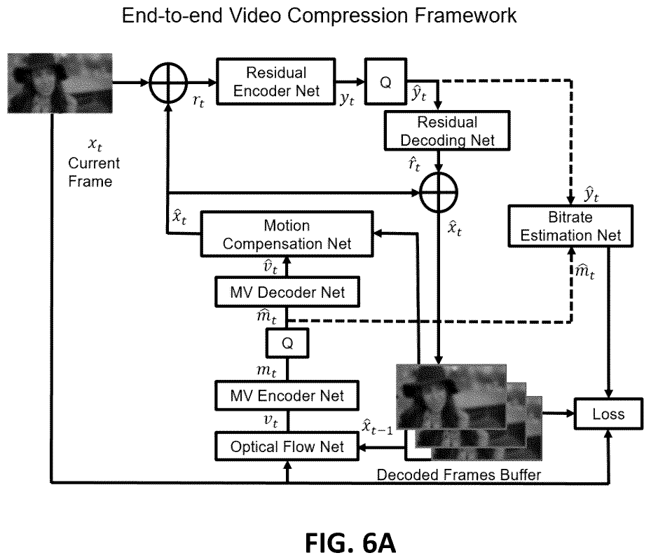

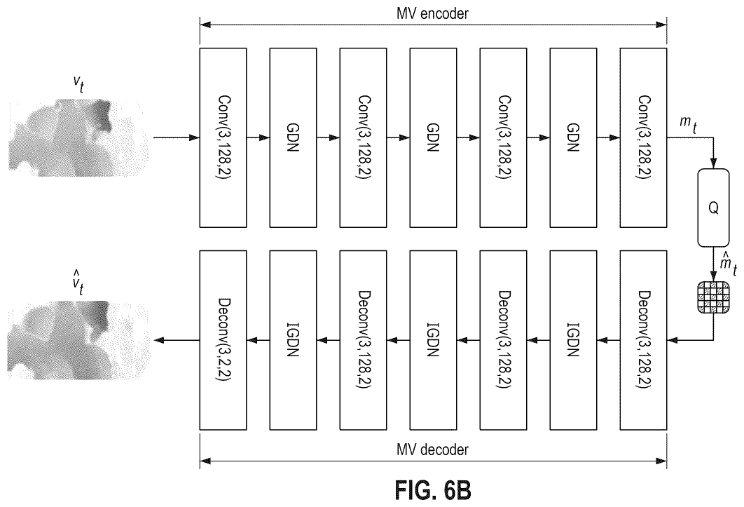

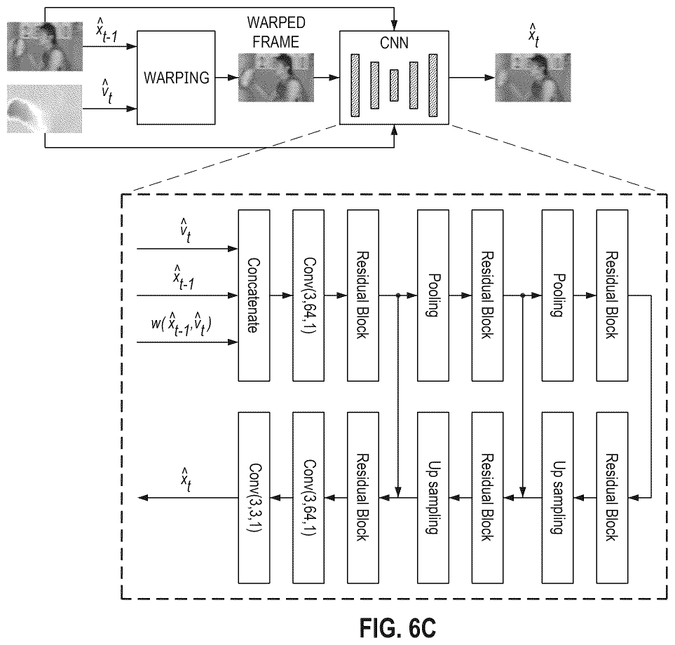

Such encoder is illustrated in FIG. 6A. In particular, FIG. 6A shows an overall structure of end-to-end trainable video compression framework. In order to compress motion information, a CNN was designated to transform the optical flow to the corresponding representations suitable for better compression. An auto-encoder style network is used to compress the optical flow. The motion vectors (MV) compression network is shown in FIG. 6B. The network architecture is somewhat similar to the ga/gs of FIG. 4. In particular, the optical flow is fed into a series of convolution operation and nonlinear transform including GDN and IGDN. The number of output channels for convolution (deconvolution) is 128 except for the last deconvolution layer, which is equal to 2. Given optical flow with the size of M×N×2, the MV encoder will generate the motion representation with the size of M/16×N/16×128. Then motion representation is quantized, entropy coded and sent to bitstream. The MV decoder receives the quantized representation and reconstruct motion information using MV encoder.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The VCM is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways, from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular You Only Look Once version 2 (YOLOv2) network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Said about disadvantages of state-of-the-art autoencoder based approach to compression are also valid for machine vision tasks.

### Increasing Coding Efficiency

As stated above, variational autoencoders have become state-of-the-art approaches for learnable image compression. Once appeared in 2017, they were supporting just a single quality mode (trade-off between rate and distortion), until variable rate approaches appeared—those models supported selection of compression quality within predefined certain range. The heart of variable rate models is a gain unit, which is a part on neural network based codec, which provides the models with ability to compress input data with different compression range. However, some gain units were designed to work in some predefined range of compression quality. The gain units are unable to match some certain bitstream size outside a predefined range of compression quality.

Thus, some embodiments of the present disclosure introduce a gain vector extrapolation solution of an autoencoder to enable content flexibly representation and transmission, without restriction to the predefined or pre-trained range of compression quality or bitstream size.

In the following, some detailed embodiments and examples related to encoder side and decoder side are provided.

### Encoding Methods

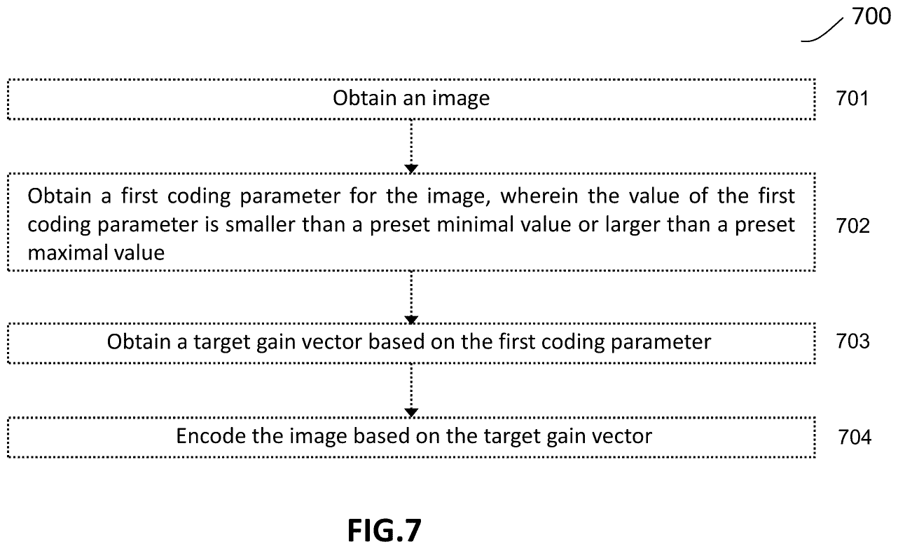

FIG. 7 is a flow diagram illustrating an exemplary method for encoding, the method comprises step 701, receive an image; step 702, receive a first coding parameter for the image, wherein a value of the first coding parameter is smaller than a preset minimal value or larger than a preset maximal value, step 703, obtain a target gain vector based on the first coding parameter; step 704, encode the image based on the target gain vector.

In step 701, an image is received. In the embodiment of the present disclosure, the image is an image to be compressed, where the image may be an image captured by a encoding device (the encoding device performs the method 700 to encode the image) through a camera, or the image may also be an image obtained from inside the encoding device (for example, the image stored in the album of the encoding device, or the picture obtained by the encoding device from cloud or other devices). The image may be a single image or a frame of a video. Also, the image may be a part of an image, i.e., an image block. It should be understood that the above-mentioned image may be an image or image block with an image compression requirement, and the present disclosure does not make any limitation on the source of the image to be processed. The image comprises luma (Y) samples and/or chroma (UV) samples.

In step 702, a first coding parameter is received, wherein a value of the first coding parameter is smaller than a preset minimal value or larger than a preset maximal value. The first coding parameter (for example, denoted as β) is a scalar input for the encoding process, which is used to select compression quality. The larger β, the larger bitstream size and better quality of reconstructed data. The preset minimal value (for example, denoted as βₛ) and the preset maximal value (for example, denoted as βₜ) are related to a pre-trained value range [βₛ, βₜ] of the first coding parameter. The preset maximal value βₜ is larger than or equal to the preset minimal value βₛ. In some implementations, the pre-trained value range of the first coding parameter β may be inconsecutive and the values of the first parameter β are finite discrete points. In the inference process, the value of the first parameter β can be extended to any value between βₛ and βₜ by applying interpolation.

In a possible design, the image comprises both luma samples and chroma samples, the first coding parameter may comprise a first component and a second component. At least one of the first component and the second component of the first coding parameter satisfy the condition that the value of the first coding parameter is smaller than a preset minimal value or larger than a preset maximal value. It is noted that the preset minimal value and the preset maximal value for luma samples and chroma samples may be different. The first component may be used to encode the luma samples and thus control the compression quality of luma samples of the image. The second component may be used to encode the chroma samples and thus control the compression quality of chroma samples of the image.

In a possible design, the image comprises both luma samples and chroma samples, a second coding parameter is obtained as well. One of the first coding parameter and the second coding parameter is used to encode the luma samples, while the other one is used to encode the chroma samples. Chroma samples and luma sample are encoded with different coding parameter β to control the compression quality separately. It is noted that the preset minimal value and the preset maximal value for luma samples and chroma samples may be different or the same, which is not limited in the present disclosure.

In the embodiments of the present disclosure, the preset minimal value βₛ and the preset maximal value βₜ may be stored on the encoding device or received from other devices, which is not limited here.

In the embodiments of the present disclosure, each value of the first coding parameter β corresponds to a gain vector, i.e., model weights of a neural network model used to encode the image. A pre-trained set of possible values of β and corresponding gain vectors are obtained during the model training stage. As stated above, the possible values of β is between the preset minimal value βₛ and the preset maximal value βₜ. In the present disclosure, the gain vector is a vector with dimension 1×d, d is an integer larger than 1. In a possible implementation, d=128 when encoding luma samples of the image. In a possible implementation, d=64 when encoding chroma samples of the image. It is noted that d may be other integers as well, such as 32, 48, 96, 144, 160, 176, 192, 256, etc.

Accordingly, in a possible embodiment, the pre-trained set of possible values of β and corresponding gain vectors are stored on the encoding device and the decoding device. In another possible embodiment, only possible values of β or the corresponding gain vectors of the pre-trained set are stored on the encoding device and the decoding device and a mapping relationship of the possible values of β and their corresponding gain vectors is stored on the encoding device and the decoding device as well. The mapping relationship indicates one-to-one correspondences between the possible values of β and the gain vectors. The mapping relationship may be a preset table or a preset objective function or any other form as long as they are the same at the encoding device and the decoding device, which is not limited here.

In a possible design, luma samples and chroma samples are trained together. Therefore, the luma samples and chroma samples share a list of possible values of the first coding parameter. However, the gain vectors obtained after the training stage are different for luma samples and chroma samples. Table 1 is an exemplary table showing the pre-trained β and corresponding gain vectors for luma samples and chroma samples. The number of pre-trained coding parameter is N, wherein N is an integer larger than 0. In a possible design, N=13. In Table 1, β₀ may be the minimal value βₛ, and β_{N-1} may be the maximal value βₜ.

TABLE 1
Luma samples and chroma samples share
the first coding parameter β

| β | Gain vectors for lum [symbol] | Gain vectors for chro [symbol] |
|---|---|---|
| β₀ | m_{Y0} | m_{UV0} |
| β₁ | m_{Y1} | m_{UV1} |
| . . . | . . . | . . . |
| β_{N-1} | m_{Y(N-1)} | m_{UV(N-1)} |

[symbol]

indicates data missing or illegible when filed

In a possible design, luma samples and chroma samples are trained separately. Therefore, the luma samples and chroma samples may not share a list of possible values of the first coding parameter. Hence, two tables are used to store the pre-trained [β, gain vector] pairs for luma samples and chroma samples. Table 2 is an exemplary table showing the pre-trained β and corresponding gain vectors for luma samples. Table 3 is an exemplary table showing the pre-trained β and corresponding gain vectors for chroma samples. The number of pre-trained coding parameter for chroma samples is N1, wherein N1 is an integer larger than 0. In a possible design, N1=13. The number of pre-trained coding parameter for chroma samples is N2, wherein N2 is an integer larger than 0. In a possible design, N2=13 as well. It is noted that N1 and N2 may be other integer values, like N1=10, N2=5, etc. It is possible that N1 is larger than or equal to or smaller than N2, which is not limited in the present disclosure. In Table 2, β₀ may be the minimal value βₛ for luma samples, and β_{N1-1} may be the maximal value βₜ for luma samples. In Table 3, β₀ may be the minimal value βₛ for chroma samples, and β_{N2-1} may be the maximal value βₜ for chroma samples.

TABLE 2
The first coding parameter β and
corresponding gain vectors for luma samples

| β | Gain vectors for lum [symbol] |
|---|---|
| β₀ | m_{Y0} |
| β₁ | m_{Y1} |
| . . . | . . . |
| β_{N1-1} | m_{Y(N1-1)} |

[symbol]

indicates data missing or illegible when filed

TABLE 3
The first coding parameter β and corresponding
gain vectors for chroma samples

| β | Gain vectors for lum [symbol] |
|---|---|
| β₀ | m_{UV0} |
| β₁ | m_{UV1} |
| . . . | . . . |
| β_{N2-1} | m_{UV(N2-1)} |

[symbol]

indicates data missing or illegible when filed

Step 703, obtaining a target gain vector based on the first coding parameter. As stated above, in the pre-trained set of possible values of β and corresponding gain vectors, the possible values of β is between the preset minimal value βₛ and the preset maximal value βₜ. The disadvantage of this method is that the image compression quality of a pre-trained model is limited by some minimal and maximal value. Even if twice more bits are spent, a quality better than a max quality cannot be obtained using the existing method. Even if lower quality below a min quality is acceptable in some situations, compressing an image with less bits is not supported by the existing method. Thus, an encoding method supporting encoding an image with any image compression quality is proposed to overcome the disadvantages of the existing method. When a target compression quality is given by the first coding parameter, a corresponding target gain vector can be obtained by using the proposed method in the present disclosure, even when the value of the first coding parameter is smaller than a preset minimal value or larger than a preset maximal value.

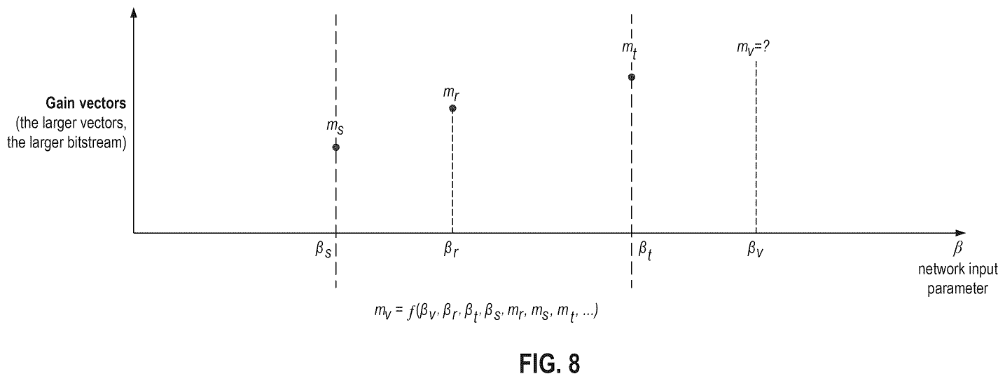

FIG. 8 is a schematic drawing illustrating the relation of the first coding parameter (i.e., network input parameter) β and the gain vectors. During training stage of the neural network (like encoder 101 in FIG. 3A), several values of β between [βₛ, βₜ] are input to the network and trained to get the corresponding gain vectors. In FIG. 8, three pairs of pre-trained [β, gain vector] are shown, which are [βₛ, mₛ], [βᵣ, mᵣ] and [βₜ, mₜ], wherein βₛ is the lower boundary of the value range of β and βₜ is the upper boundary of the value range of β. It is noted that the present disclosure is not limited to such implementation and in general, other possible number of [β, gain vector] pairs may be pre-trained, and the often situation is that more than 3 pairs of [β, gain vector] pairs are pre-trained, for example, 13 pairs of [β, gain vector] pairs are pre-trained in a possible design.

In the present disclosure, as shown in FIG. 8, an extrapolation method is proposed to obtain the target gain vector based on the first coding parameter. In the inference stage, given a specific value (denoted as βᵥ) of the first coding parameter, a target gain vector (denoted as my) may be derived according to an objective function, i.e., mᵥ=ƒ(βᵥ, βᵣ, βₜ, βₛ, mᵣ, mₛ, mₜ, . . . ).

In a possible embodiment, only the nearest pre-trained input parameter and its corresponding gain vector are used to derive the new gain vector mᵥ for βᵥ. For example, when βᵥ is larger than the preset maximal value βₜ, only the maximal value βᵣ and its corresponding gain vector mₜ are used to derive mᵥ. In this situation, mᵥ=ƒ(βᵥ, βₜ, mₜ). One possible implementation of the function mᵥ=ƒ(βᵥ, βₜ, mₜ) is:

$${m}_{ν} = {m}_{t} * {( \frac{{β}_{ν}}{{β}_{t}} )}^{K} , \qquad ( 1 )$$

wherein K is a hyper parameter, which is used to control the relation between mᵥ and its nearest pre-trained gain vector. The value of K may be preset or depend on βᵥ.

Similarly, when βᵥ is smaller than the preset minimal value βₛ, only the minimal value βₛ and its corresponding gain vector ms are used to derive mᵥ. In this situation, mᵥ=ƒ(βᵥ, βₛ, mₛ). Similarly, one possible implementation of the function mᵥ=ƒ(βᵥ, βₛ, mₛ) is:

$${m}_{ν} = {m}_{s} * {( \frac{{β}_{ν}}{{β}_{s}} )}^{K} , \qquad ( 2 )$$

similar to equation (1), wherein K is a hyper parameter, which is used to control the relation between mᵥ and its nearest pre-trained gain vector. The value of K may be preset or depend on βᵥ.

Both in equation (1) and equation (2), the value of K may be preset and stored on encoding device and decoding device, no transmission of K is needed, therefore the size of bitstream can be smaller. A default value of K may be 1. In another possible implementation, the value of K may depend on βᵥ. Different values of K can be used in equation (1) and equation (2), for example, K=1.5 in equation (1) and K=0.5 in equation (2).

The above embodiment proposes to derive a target gain vector outside a predefined range, thus any desired image compression quality can be achieved. In situations where lower distortion is desired, a higher compression quality is achievable by extrapolation the predefined maximal gain vector. In situations where lower bitstream size is desired, a lower compression quality is achievable by extrapolation the predefined minimal gain vector.

In a possible embodiment, the most two nearest pre-trained values of β and their corresponding gain vectors are used to obtain the target gain vector mᵥ for βᵥ. For example, when βᵥ is larger than the preset maximal value βₜ, the maximal value βₜ and its corresponding gain vector mₜ, as well as the next nearest pre-trained value of β to βᵥ (denoted as βᵣ in FIG. 8) and its corresponding gain vector mᵣ are used to derive mᵥ for βᵥ. In this situation, mᵥ=ƒ(βᵥ, βᵣ, βₜ, mᵣ, mₜ). One possible implementation of the function: mᵥ=ƒ(βᵥ, βᵣ, βₜ, mᵣ, mₜ) is:

$${m}_{ν} = {m}_{t} + \frac{{m}_{t} - {m}_{r}}{{β}_{t} - {β}_{r}} * K * ( {β}_{ν} - {β}_{t} ) , \qquad ( 3 )$$

wherein K is a hyper parameter, which is used to control the relation between mᵥ and its next nearest pre-trained gain vector. The value of K may be preset and stored on encoding device and decoding device. The value of K may be preset and stored on encoding device and decoding device. A default value of K may be 1. In another possible implementation, the value of K may depend on βᵥ, for example,

$$K = \frac{{β}_{v} - {β}_{t}}{{m}_{v} - {m}_{t}} * \frac{{m}_{t}}{{β}_{t}} .$$

Similarly, when βᵥ is smaller than the preset minimal value βₛ, the minimal value βₛ and its corresponding gain vector mₛ, as well as the next nearest pre-trained value of β to βᵥ (denoted as βᵣ in FIG. 8) and its corresponding gain vector mᵣ are used to derive mᵥ for βᵥ. In this situation, mᵥ=ƒ(βᵥ, βᵣ, βₛ, mᵣ, mₛ). One possible implementation of the function mᵥ=ƒ(βᵥ, βᵣ, βₛ, mᵣ, mₛ) is:

$${m}_{ν} = {m}_{s} + \frac{{m}_{r} - {m}_{s}}{{β}_{r} - {β}_{s}} * K * ( {β}_{ν} - {β}_{s} ) , \qquad ( 4 )$$

similar to equation (3), wherein K is a hyper parameter, which is used to control the relation between my and its next nearest pre-trained gain vector. The value of K may be preset and stored on encoding device and decoding device. A default value of K may be 1. In another possible implementation, the value of K may depend on βᵥ, for example,

$$K = \frac{{β}_{v} - {β}_{s}}{{m}_{v} - {m}_{s}} * \frac{{m}_{s}}{{β}_{s}} .$$

It is noted that in the example of FIG. 8, only three pre-trained pairs of [β, gain vector] are shown, therefore the next nearest pre-trained values of β to βᵥ are both denoted as βᵣ in equation (3) and equation (4). FIG. 8 is a schematic drawing, in other possible embodiments, more than 3 pairs of [β, gain vector] are pre-trained, the next nearest pre-trained values of β to βᵥ when βᵥ is smaller than βₛ and when βᵥ is larger than βₜ should be different.

Both in equation (3) and equation (4), when K is set to a default value, no transmission of K is needed, therefore the size of bitstream can be smaller. A default value of K may be 1. In another possible implementation, the value of K may depend on βᵥ. Different values of K can be used in equation (3) and equation (4), for example,

K=1 for large βᵥ and

$$K = \frac{{β}_{v} - {β}_{s}}{{m}_{v} - {m}_{s}} * \frac{{m}_{s}}{{β}_{s}}$$

for smaller βᵥ.

Using more pre-trained pairs of [β, gain vector] leads to better performance.

In a possible embodiment, more than one pairs of [β, gain vector] are used to derive the new gain vector mᵥ for βᵥ. In a possible implementation of this embodiment, N (N>2) nearest pre-trained values of β to βᵥ and their corresponding gain vectors are used to derive the target gain vector mᵥ for βᵥ by polynomial extrapolation. For example, when βᵥ is larger than the preset maximal value βₜ, the target gain vector satisfies the following condition:

$${m}_{v} = {m}_{t} + {\sum }_{n = 1}^{n = N - 1} f ( {β}_{s} , {β}_{r} , {β}_{t} , {m}_{s} , {m}_{r} , {m}_{t} , n , … ) * {( {β}_{v} - {β}_{t} )}^{n} , \qquad ( 5 )$$

In a possible design, a specific form of equation (5) is:

$${m}_{v} = {m}_{t} + \frac{{m}_{t} - {m}_{s}}{{β}_{t} - {β}_{s}} * ( {β}_{v} - {β}_{t} ) + \frac{1}{2} * [ \frac{\frac{{m}_{t} - {m}_{r}}{{β}_{t} - {β}_{r}} - \frac{{m}_{r} - {m}_{s}}{{β}_{r} - {β}_{s}}}{\frac{{β}_{t} - {β}_{s}}{2}} ] * {( {β}_{v} - {β}_{t} )}^{2} .$$

Similarly, when βᵥ is smaller than the preset minimal value βₛ, the target gain vector satisfies the following condition:

$${m}_{v} = {m}_{s} + {\sum }_{n = 1}^{n = N - 1} f ( {β}_{s} , {β}_{r} , {β}_{t} , {m}_{s} , {m}_{r} , {m}_{t} , n , … ) * {( {β}_{v} - {β}_{s} )}^{n} , \qquad ( 6 )$$

In a possible design, a specific form of equation (6) is:

$${m}_{v} = {m}_{s} + \frac{{m}_{t} - {m}_{s}}{{β}_{t} - {β}_{s}} * ( {β}_{v} - {β}_{s} ) + \frac{1}{2} * [ \frac{\frac{{m}_{t} - {m}_{r}}{{β}_{t} - {β}_{r}} - \frac{{m}_{r} - {m}_{s}}{{β}_{r} - {β}_{s}}}{\frac{{β}_{t} - {β}_{s}}{2}} ] * {( {β}_{v} - {β}_{s} )}^{2}$$

In a possible embodiment, all the pre-trained pairs of [β, gain vector] are used to derive the new gain vector mᵥ for βᵥ. And each pre-trained value of β is given a weight to control the contribution of different pre-trained values of β and their corresponding gain vectors.

It is noted that in the above possible forms of the function, a bias or offset can be added as well. The form of the function is not limited in the present disclosure. All the operations related to gain vector are elementwise operations, which means the operation is performed on individual element of the gain vector.

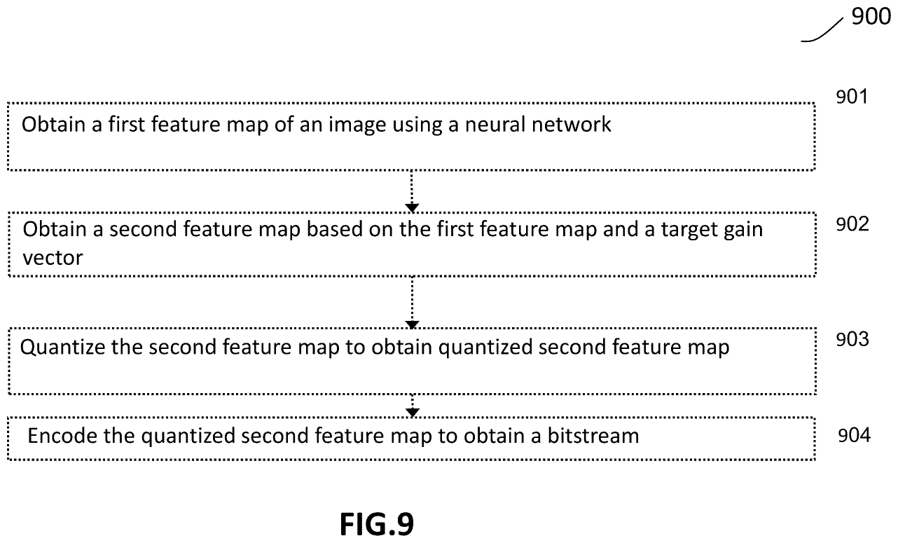

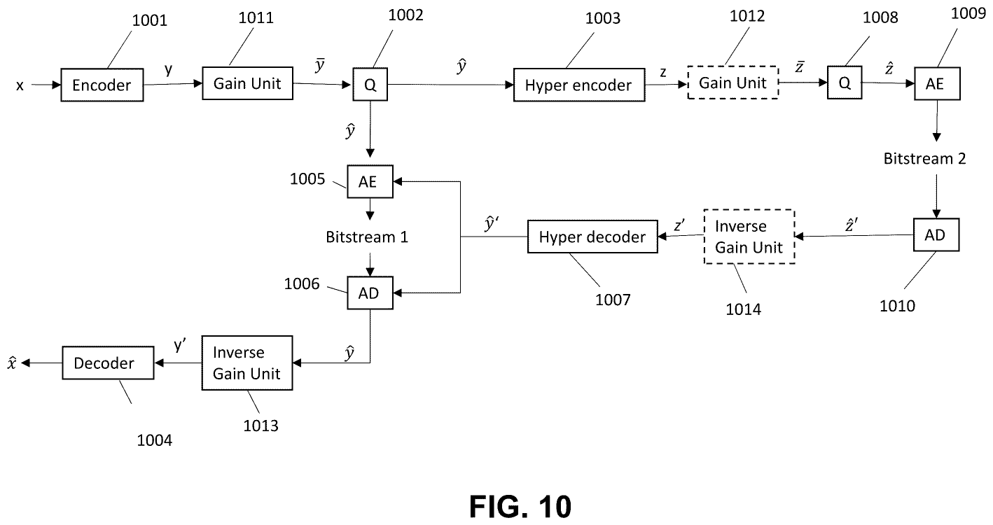

In a possible design, when the image comprises only chroma samples or only luma samples, a target gain vector is obtained in step 703; when the image comprises both chroma samples and luma samples, a target gain vector for luma samples is obtained in step 703 and a target gain vector for chroma samples is obtained in step 703 as well, maybe by performing the step 703 twice. Step 704, encoding the image based on the target gain vector. After obtaining the target gain vector in step 703, the target gain vector is used to encode the image. FIG. 9 is a flow chart of an exemplary method for encoding an image based on a target gain vector and FIG. 10 is an exemplary VAE framework which can perform the method 900 in FIG. 9. As is clear to those skilled in the art, this embodiment may be combined with any of the above-mentioned embodiments and any of their possible designs or possible implementations.

The encoding method 900 shown in FIG. 9 comprises, step 901, obtain a first feature map of an image using a neural network, step 902, obtain a second feature map based on the first feature map and a target gain vector, step 903, quantize the second feature map to obtain a quantized second feature map, step 904, encode the quantized second feature map to obtain a bitstream.

In step 901, a latent representation (i.e., a first feature map) of the image is obtained using a neural network. In a VAE framework, the function of the neural network may be implemented by the encoder 1001 shown in FIG. 10. The encoder 1001 maps an input image x (i.e., the image) into a latent representation (denoted by y) via the function y=f(x). The function f( ) is a transformation function that converts the input signal x into a more compressible representation y. Usually, y is a tensor with a shape of w×h×d, for example, w×h×128 or w×h×64, wherein w represents the feature map width, h represents the feature map height, and d represents a number of the feature map channels. It is noted that the feature map width and the feature map height may be equal or not equal, which is not limited here. The feature map channels may be other integer values as well, for example, 32, 48, 96, 144, 160, 176, 192, 256, etc., which is not limited in the present disclosure. In a possible design, the number of feature map channels for luma samples and chroma samples may be different, for example, 128 for luma samples and 64 for chroma samples. Although the unit 1001 is called “encoder”, it is also possible to call the complete encoding network described in FIG. 10 as “encoder”. The process of encoding in general means the unit (module) that converts an input to an encoded (e.g. compressed) output.

In step 902, after the first feature map of the image is obtained in step 901, further calculation can be performed to the first feature map based on a target gain vector. The target gain vector may be the target gain vector obtained in step 703 of method 700. In a possible implementation, the function of step 902 can be performed by a gain unit 1011 after the encoder 1001. The input of the gain unit 1011 (denoted by y) is the output of the encoder 1001. The gain unit 1011 further transforms the first feature map with the target gain vector. As stated in step 702, the gain vector is a vector with dimension 1×d, d is an integer larger than 1. In the present disclosure, the d equals to a number of the feature map channels of y. Therefore, each element of the target gain vector can map to a feature map channel of y. In a possible implementation, the gain unit 1011 multiplies the target gain vector with the first feature map to obtain the second feature map. The output of the gain unit 1011 is denoted as y̅.

It is noted that step 703 need to be performed before step 902, actions recited in other steps of method 700 and 900 can be performed in a different order and still achieve desirable results. As one example, the processes depicted in the accompanying figures do not necessarily require the particular order shown, or sequential order, to achieve desirable results. In certain implementations, multitasking and parallel processing may be advantageous. For example, step 702 may be performed before step 901, or step 702 may be performed after step 901, or step 702 and step 901 may be performed in parallel.

In step 903, the second feature map obtained in step 902 is quantized. The process of quantization may be performed by the quantizer 1002 shown in FIG. 10. The quantizer 1002 transforms the latent representation y into the quantized latent representation ŷ with (discrete) values by ŷ=Q(y̅), with Q representing the quantizer function.

In step 904, the quantized second feature map obtained in step 903 is further encoded into a bitstream 1 using entropy encoding. The entropy encoding process may be performed by the arithmetic encoder (AE) 1005 shown in FIG. 10. Samples of the quantized latent representation ŷ (i.e., the quantized second feature map) are converted into a string of binary digits (which is then included in a bitstream that may comprise further portions corresponding to the encoded image or further side information). It is noted that the arithmetic encoder 1005 is an implementation of entropy coding. AE can be replaced by other means of entropy coding. In information theory, an entropy encoding is a lossless data compression scheme that is used to convert the values of a symbol into a binary representation which is a revertible process.

The output of the step 904 is a bitstream, which are then provided (transmitted) to the decoding process. As is clear to those skilled in the art, this embodiment may be combined with any of the above-mentioned embodiments and any of their possible designs or possible implementations.

In a possible design, when the image comprises only chroma samples or only luma samples, a target gain vector is obtained in step 703 and the method 900 is performed to encode the image based on the target gain vector; when the image comprises both chroma samples and luma samples, a target gain vector for luma samples is obtained in step 703 and a target gain vector for chroma samples is obtained in step 703 as well, maybe by performing the step 703 twice, and the luma samples and chroma samples are encoded independently using method 900 based on their corresponding target gain vector. The encoded luma samples and chroma samples may be packed into a bitstream to store or transmit.

In a possible embodiment, the encoding method 700 further comprises encoding the first coding parameter into a bitstream. In some situations, different images may need to be compressed with different qualities, therefore, the encoding method 700 can be used to encode different images with the first coding parameter setting to different values. The proposed method 700 enables to achieve different compression qualities with a single pre-trained model, especially to achieve compression qualities outside a pre-trained range.

The first coding parameter is signaled in the bitstream (e.g. as a first flag, such as compression_quality_level) and transmitted to a decoding device, so that the decoding device can decode the coded image data based on the first coding parameter. In a possible implementation, the first coding parameter is encoded or signaled in picture parameter set (PPS) of the bitstream. In a possible implementation, the first coding parameter is encoded or signaled in sequence parameter set (SPS) of the bitstream. In a possible implementation, the first coding parameter is encoded or signaled in picture header (PH) or slice header (SH) of the bitstream.

In a possible design, the number of bits used to signal the first coding parameter (first flag) in the bitstream is less than or equal to 16. For example, the first parameter may take 15 bits in the bitstream.

In some possible designs, the first coding parameter is signaled in other forms to save bits for transmitting the first coding parameter. For example, in a possible design, the first coding parameter is signaled in its base 2 logarithmic form. In another possible design, the first coding parameter is signaled in its base 2 logarithmic form with a bias. The base of logarithmic can be other values, like 10, which is not limited here. In this way, the bits used to transmit the first coding parameter may be decreased to less than or equal to 4 bits.

Optionally, side information z output by hyper encoder 1003 may go through a gain unit 1012 before quantizing. The function of gain unit 1012 is similar to gain unit 1011, while the gain vector used in gain unit 1012 and gain unit 1011 may be different. This embodiment enables to encode the side information in a more flexible way.

In a possible embodiment, the image comprises only luma samples, the method 700 is used to encode the luma samples based on a first coding parameter to obtain a bitstream and the first coding parameter is signaled as a first flag (such as compression_quality_level) in the bitstream as stated above.

In a possible embodiment, the image comprises only chroma samples, the method 700 is used to encode the chroma samples based on a first coding parameter to obtain a bitstream and the first coding parameter is signaled as a first flag (such as compression_quality_level) in the bitstream as stated above.

In a possible embodiment, the image comprises both luma samples and chroma samples, when the luma samples are encoded based on a first coding parameter using method 700, the chroma samples are encoded based on a second coding parameter using method 700; or when the chroma samples are encoded based on a first coding parameter using method 700, the luma samples are encoded based on a second coding parameter using method 700. It is noted that some steps of method 700 may be performed only once when encoding the image with both luma samples and chroma samples, like step 701. Both the first coding parameter and the second coding parameter are signaled in the bitstream as stated above, for example, the first coding parameter is signaled as a first flag (such as compression_quality_level_luma) and the second coding parameter is signaled as a second flag (such as compression_quality_level_chroma), or the first coding parameter is signaled as a first flag (such as compression_quality_level_chroma) and the second coding parameter is signaled as a second flag (such as compression_quality_level_luma). The second coding parameter is signaled in a same way as the first coding parameter is signaled. Therefore, the number of bits used for transmitting the coding parameters are doubled. At least one of the values of first coding parameter and the second coding parameter is smaller than a preset minimal value or larger than a preset maximal value.

In a possible embodiment, the image comprises both luma samples and chroma samples, the first coding parameter comprises a first component and a second component. The luma samples are encoded based on the first component using method 700, the chroma samples are encoded based on the second component using method 700. It is noted that some steps of method 700 may be performed only once when encoding the image with both luma samples and chroma samples, like step 701. Both the first component and the second component are signaled in the bitstream as stated above, for example, the first component is signaled as a first flag (such as compression_quality_level_luma) and the second component is signaled as a second flag (such as compression_quality_level_chroma). The first component and the second component both are signaled in a same way as the first coding parameter is signaled as stated above. Therefore, the number of bits used for transmitting the first coding parameter are doubled.

In a possible embodiment, different regions of a whole image may be encoded based on different coding parameter βᵥ, and the several coding parameters βᵥ are signaled to in the bitstream to be transmitted to other devices. For example, a region of interest may be encoded with a larger βᵥ to get better compression quality, a background region may be encoded with a smaller βᵥ to get a smaller bitstream size. The proposed method make it possible to achieve different compression qualities for different regions of a single image, the encoding process is more flexible and can satisfy different compression requirements for different situations.

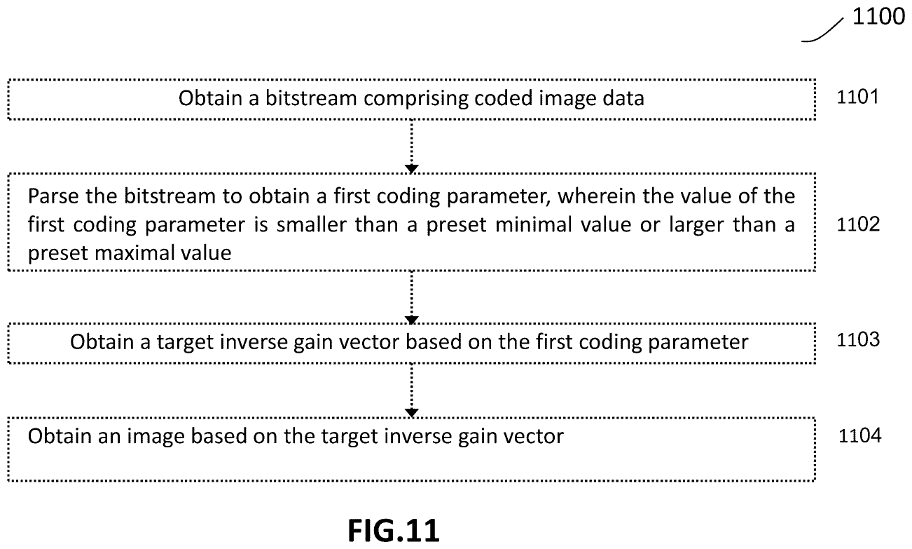

The embodiment according to FIG. 7 may be configured to provide output readily decoded by the decoding method described with reference to FIG. 11. The method 700 of FIG. 7 will be described as being performed by a neural network system of one or more computers located in one or more locations. For example, a system configured to perform image compression, e.g., the neural network of FIG. 1 can perform the method 700. In general, the above-mentioned embodiments may be combined in order to provide more flexibility.

### Decoding Methods

FIG. 11 is a flow diagram illustrating an exemplary method for decoding an image based on a neural network architecture, comprising: step 1101, obtain a bitstream comprising coded image data; step 1102, parse the bitstream to obtain a first coding parameter, wherein a value of the first coding parameter is smaller than a preset minimal value or larger than a preset maximal value; step 1103, obtain a target inverse gain vector based on the first coding parameter; step 1104, obtain an image based on the target inverse gain vector.

In step 1101, a bitstream comprising coded image data is obtained, maybe from an encoding device or from a distributing device. The bitstream may include information of some side information (e.g. mean value or variance of encoded samples . . . ), information of some coding parameters (e.g. coding mode, compression quality parameters, quantizing parameters . . . ).

In step 1102, parse the bitstream to obtain a first coding parameter, wherein a value of the first coding parameter is smaller than a preset minimal value or larger than a preset maximal value. The first coding parameter (for example, denoted as β) is a scalar input for the decoding process, which is used to select compression quality.

A first flag (such as compression_quality_level) is signaled in the bitstream to specify the compression quality (i.e., first coding parameter β) of an image. In a possible design, the first flag is the compression quality, and may takes 16 bits or 15 bits to store and transmit. In this design, the first coding parameter β is directly parsed from the bitstream. In another possible design, the first flag is base 2 logarithmic form of the first coding parameter (such as log 2_compression_quality_level or log 2_compression_quality_level_minus1), and the first coding parameter can be derived as follows: first coding parameter β=1<<first flag; or first coding parameter β=1<< (first flag+bias), wherein “<<” means left shifting, the first flag may be an integer ranging from 0 to 16, and the bias may be 1, 2, 3, 4, 5, 8, etc.

In a possible embodiment, a first flag and a second flag are signaled in the bitstream to specify the compression quality of an image. When the first flag (such as compression_quality_level_luma) is related to a first coding parameter (denoted as β_{Y}) specifying the compression quality of luma samples of the image, the second flag (such as compression_quality_level_chroma) is related to a second coding parameter (denoted as β_{UV}) specifying the compression quality of chroma samples of the image. When the first flag (such as compression_quality_level_chroma) is related to a first coding parameter (denoted as β_{UV}) specifying the compression quality of chroma samples of the image, the second flag (such as compression_quality_level_luma) is related to a second coding parameter (denoted as β_{Y}) specifying the compression quality of luma samples of the image. Both the first coding parameter and the second coding parameter can be derived using the method stated in the former paragraph. At least one of the values of first coding parameter and the second coding parameter is smaller than a preset minimal value or larger than a preset maximal value.

In a possible embodiment, a first flag is signaled in the bitstream to specify the compression quality of an image. The first flag comprises a first component (such as compression_quality_level_luma) and a second component (such as compression_quality_level_chroma). The first component is related to a first coding parameter (denoted as β_{Y}) specifying the compression quality of luma samples of the image, the second component is related to a second coding parameter (denoted as β_{UV}) specifying the compression quality of chroma samples of the image. Both the first coding component and the second coding component can be derived using the method stated in the above paragraph.

In step 1103, after obtaining the first coding parameter, a target inverse gain vector is obtained based on the first coding parameter. During the network training stage, a pre-trained set of possible values of β and corresponding gain vectors is obtained and stored on both encoding device and decoding device, the possible values of β is between the preset minimal value βₛ and the preset maximal value βₜ. Therefore, a target gain vector mᵥ can be obtained using the method described with reference to FIG. 8. Then, a target inverse gain vector mᵥ′ can be obtained based on the target gain vector, and the target inverse gain vector mᵥ′ satisfies the following condition: mᵥ′*mᵥ=C, wherein C is a vector whose elements are all constants, and * means element wise multiplication operation. In a possible design, C is a constant, and * means dot multiplication operation.

In a possible design, a pre-trained set of possible values of β and corresponding inverse gain vectors is obtained during the training stage and then stored on the decoding device. Therefore, a target inverse gain vector mᵥ′ can be obtained using the method described with reference to FIG. 8.

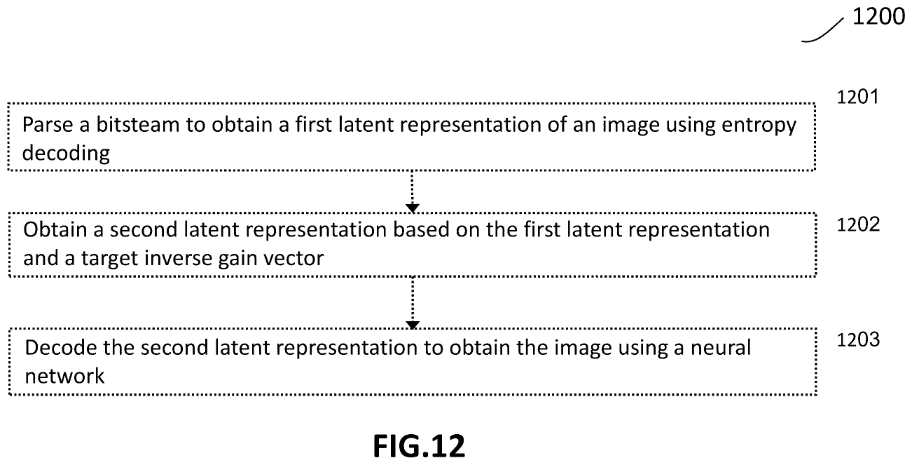

Step 1104, obtaining an image based on the target inverse gain vector. After obtaining the target inverse gain vector in step 1103, the target inverse gain vector is used to decode the image. FIG. 12 is a flow chart of an exemplary method for decoding the image based on a target inverse gain vector and FIG. 10 is an exemplary VAE framework which can perform the method 1200 in FIG. 12. In general, the above-mentioned embodiments and any of their possible designs or possible implementations may be combined in order to provide more flexibility.

The decoding method 1200 shown in FIG. 12 comprises step 1201, parse a bitstream to obtain a first latent representation of an image using entropy decoding; step 1202, obtain a second latent representation based on the first latent representation and a target inverse gain vector; step 1203, decode the second latent representation to obtain the image using a neural network.

In step 1201, an entropy decoding process is performed to convert binary digits back to sample values (i.e., first latent representation, denoted by ŷ). In a possible implementation, the entropy decoding is provided by the arithmetic decoding module 1006 shown in FIG. 10. It is noted that the arithmetic decoder (AD) 1006 is an implementation of entropy decoding. AD can be replaced by other means of entropy decoding. Usually, ŷ is a tensor with a shape of w×h×d, for example, w×h×128 or w×h×64, wherein w represents the feature map width, h represents the feature map height, and d represents a number of the feature map channels. It is noted that the feature map width and the feature map height may be equal or not equal, which is not limited here. The feature map channels may be other integer values as well, for example, 32, 48, 96, 144, 160, 176, 192, 256, etc., which is not limited in the present disclosure. In a possible design, the number of feature map channels for luma samples and chroma samples may be different, for example, 128 for luma samples and 64 for chroma samples.

In step 1202, after the first latent representation of the image is obtained in step 1201, further calculation can be performed to the first latent representation based on a target inverse gain vector. The target inverse gain vector may be the target inverse gain vector obtained in step 1103 of method 1100. In a possible implementation, the function of step 1202 can be performed by an inverse gain unit 1013 after the AD 1006. The input of the gain unit 1013 (denoted by ŷ) is the output of the AD 1006. The inverse gain unit 1013 further transforms the first latent representation with the target inverse gain vector. As stated in step 1202, the inverse gain vector is a vector with dimension 1×d, d is an integer larger than 1. In the present disclosure, the d equals to a number of the feature map channels of ŷ. Therefore, each element of the target inverse gain vector can map to a feature map channel of ŷ. In a possible implementation, the inverse gain unit 1013 multiplies the target inverse gain vector with the first latent representation to obtain the second latent representation. The output of the inverse gain unit 1013 is denoted as y′.

It is noted that step 1103 need to be performed before step 1202, actions recited in other steps of method 1100 and 1200 can be performed in a different order and still achieve desirable results. As one example, the processes depicted in the accompanying figures do not necessarily require the particular order shown, or sequential order, to achieve desirable results. In certain implementations, multitasking and parallel processing may be advantageous. For example, step 1102 may be performed before step 1201, or step 1102 may be performed after step 1201, or step 1102 and step 1201 may be performed in parallel.

In a possible embodiment, a target gain vector is obtained in step 1103′ (which is not shown in FIG. 11) and then the bitstream is decoded to obtain an image based on the target gain vector in step 1104′ (which is not shown in FIG. 11). In this embodiment, the inverse gain unit 1013 multiplies the reciprocal of the target inverse gain vector with the first latent representation to obtain the second latent representation.

In step 1203, the second latent representation obtained in step 1202 is further decoded into an image using a neural network. In a VAE framework, the function of the neural network may be implemented by the decoder 1004 shown in FIG. 10. Although the unit 1004 is called “decoder”, it is also possible to call the complete decoding network described in FIG. 10 as “decoder”. The process of decoding in general means the unit (module) that converts a latent representation to an image output.

The output of the step 1203 is an image \hat{x}, which is more similar to x, the better.

Optionally, when side information z output by hyper encoder 1003 is processed by a gain unit 1012 before quantizing. An inverse gain unit 1014 is used to process the output of AD 1010 in FIG. 10.

As is clear to those skilled in the art, this embodiment may be combined with any of the above-mentioned embodiments and any of their possible designs or possible implementations. Side information may also be provided.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

A simple example is provided to illustrate the technical effect of the provided method, based on the framework shown in FIG. 10. Suppose the output of encoder 1001 is y=8.53, method: no gain vector is used to process y, then after quantizing ŷ=9, after lossless AE 1005 and lossless AD 1006, we get ŷ=9, then the loss in latent representation space is (9−8.53)/8.53=5.5%; the proposed method: a gain vector (e.g. m=5) is used to process y, then we get y̅=y*m=42.65, after quantizing ŷ=43, after lossless AE 1005 and lossless AD 1006, we get ŷ=43, then an inverse gain vector (e.g. m′=⅕) is used to process ŷ, then we get y′=43*⅕=8.6, then the loss in latent representation space is (8.6−8.53)/8.53=0.8%.

As illustrated in the above simple example, the proposed method in the present disclosure leads to much less distortion, especially when the gain vector is of large value.

### Encoding Devices and Decoding Devices

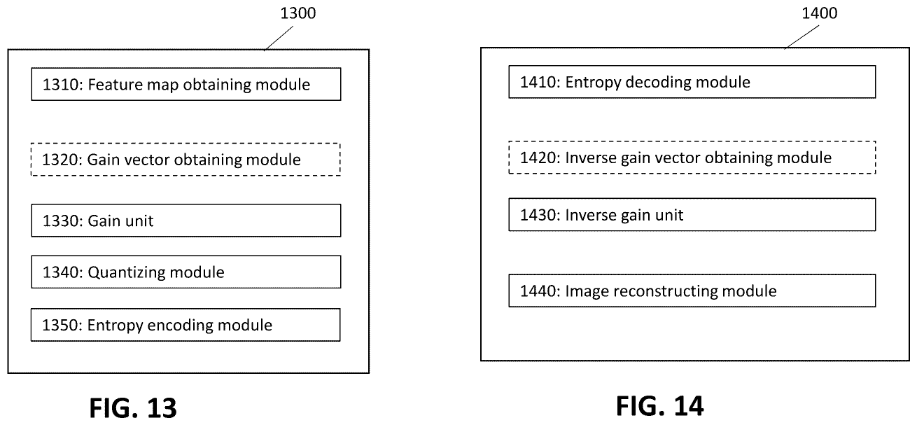

Moreover, as already mentioned, the present disclosure also provides devices which are configured to perform the steps of the methods described above. FIG. 13 shows a encoding device 1300 for encoding for processing by a neural network based unit. The device 1300 comprises a feature map obtaining module 1310 configured to obtain a first feature map from an input image; a gain unit 1330 configured to transform the first feature map based on a target gain vector to obtain a second feature map, a quantizing module 1340 configured to quantize the second feature map to obtain a quantized second feature map, an entropy encoding module 1350 configured to encode the quantized second feature map to obtain a bitstream (for example, by using entropy encoding). Optionally, the device 1300 may further comprise a gain vector obtaining module 1320 configured to, obtain the target gain vector based on a first coding parameter.

Corresponding to the abovementioned encoding device 1300, a decoding device 1400 is shown in FIG. 14 for decoding a bitstream to reconstruct an image by a neural network based unit. The device may comprise: an entropy decoding module 1410 configured to parse a bitstream to obtain a first latent representation of an image using entropy decoding; an inverse gain unit 1430 configured to obtain a second latent representation based on the first latent representation and a target inverse gain vector; an image reconstructing module configured to decode the second latent representation to obtain the image using a neural network. Optionally, the device 1400 may further comprise an inverse gain vector obtaining module 1420 configured to, obtain the target inverse gain vector based on a first coding parameter.

It is noted that these devices may be further configured to perform any of the additional features including exemplary implementations mentioned above. For example, a device is provided for decoding a feature map for processing by a neural network based on a bitstream, the device comprising a processing circuitry configured to perform steps of any of the decoding methods discussed above. Similarly, a device is provided for encoding a feature map for processing by a neural network into a bitstream, the device comprising a processing circuitry configured to perform steps of any of the encoding methods discussed above.

Further devices may be provided, which make use of the devices 1300 and/or 1400. For instance a device for image or video encoding may include the encoding device 1300. In addition, it may include the decoding device 1400. A device for image or video decoding may include the decoding device 1400 and/or the encoding device 1300.

Further, a coding system may be provided, which make use of the devices 1300 and/or 1400. For instance, the coding system may be deployed in a server. The server receives a bitstream, then using the device 1400 or other decoders to decode the bitstream to obtain images, then the images are encoded by using the device 1300 or other encoders. After encoding, the newly obtained bitstream is stored and/or transmitted to other devices.

### Some Exemplary Implementations in Hardware and Software

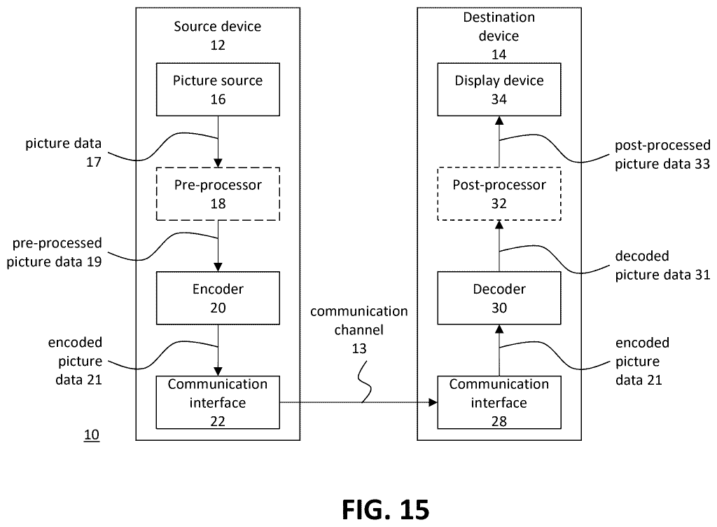

The corresponding system which may deploy the above-mentioned encoder-decoder processing chain is illustrated in FIG. 15. FIG. 15 is a schematic block diagram illustrating an example coding system, e.g. a video, image, audio, and/or other coding system (or short coding system) that may utilize techniques of this present disclosure. Video encoder 20 (or short encoder 20) and video decoder 30 (or short decoder 30) of video coding system 10 represent examples of devices that may be configured to perform techniques in accordance with various examples described in the present disclosure. For example, the video coding and decoding may employ neural network such which may be distributed and which may apply the above-mentioned bitstream parsing and/or bitstream generation to convey feature maps between the distributed computation nodes (two or more).

As shown in FIG. 15, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 15 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 15 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 15 may vary depending on the actual device and application.

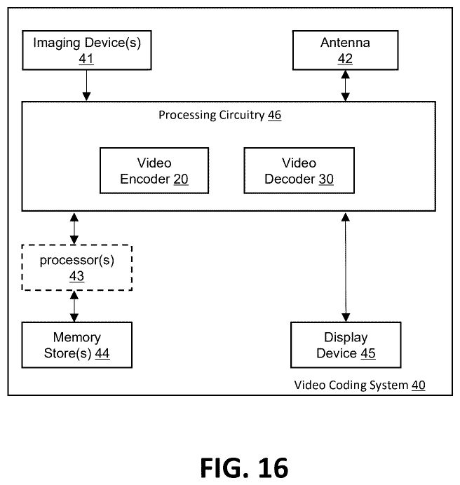

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 16.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 15 is merely an example and the techniques of the present disclosure may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

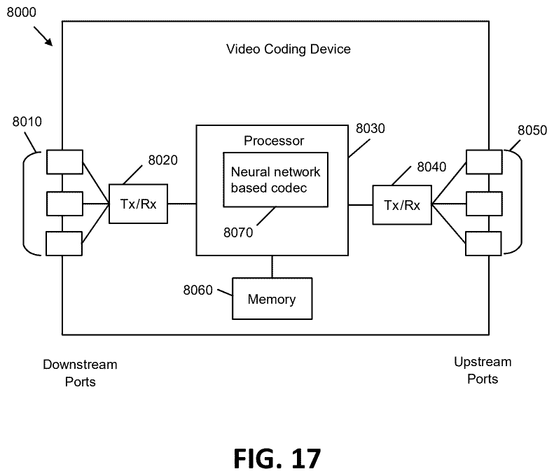

FIG. 17 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 15 or an encoder such as video encoder 20 of FIG. 15.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICS, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random-access memory (RAM), ternary content-addressable memory (TCAM), and/or static random-access memory (SRAM).

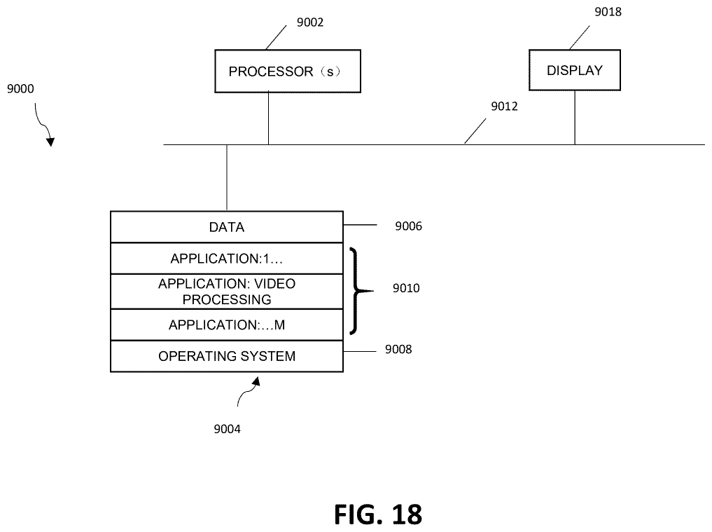

FIG. 18 is a simplified block diagram of an apparatus that may be used as either or both of the source device 12 and the destination device 14 from FIG. 15 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a ROM device or a RAM device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

In one possible embodiment, an exemplary method for storing a bitstream is provided, the method includes: obtaining a bitstream according to any one of the encoding methods illustrated before; storing the bitstream in a storage medium.

Optionally, the method further includes performing encryption processing on the bitstream to obtain an encrypted bitstream and storing the encrypted bitstream in the storage medium.

It should be understood that any of the known encryption methods may be employed.

Optionally, the method further includes: performing segmentation processing on the bitstream to obtain multiple bitstream segments; storing the plurality of bitstream segments into a storage medium.

Optionally, the method further includes: obtaining at least one backup of the bitstream, and storing the at least one backup in a storage medium. It should be understood that the at least one backup of the bitstream can be stored in a different storage medium than the storage medium that store the original bitstream.

Optionally, the method further includes receiving a plurality of bitstreams generated according to any one of the encoding methods illustrated before, separately allocating address information or identification information to the plurality of bitstreams and storing the bitstreams in a corresponding location according to the address information or identification information corresponding to the multiple bitstreams.

Optionally, the method further includes classifying the bitstreams to obtain at least two bitstreams, where the at least two bitstreams comprise a first bitstream and a second bitstream, and storing the first bitstream in a first storage space, and storing the second bitstream in a second storage space.

Optionally, the method further includes: sending, by a video streaming device, the bitstream to a terminal device, where the video streaming device can be a content server or a content delivery server.

In one possible embodiment, an exemplary system for storing a bitstream is provided, the system, including a receiver configured to receive a bitstream generated by any one of the before encoding methods, and a processor configured to perform encryption processing on the bitstream to obtain an encrypted bitstream, and a computer readable storage medium configured to store the encrypted bitstream.

Optionally, the system includes several storage mediums, and the several storage mediums can be deployed in different locations. And a plurality of bitstreams may be stored in different storage media in a distributed manner. For example, the several storage mediums include: a first storage medium, configured to store a first bitstream; a second storage medium, configured to store a second bitstream.

Optionally, the system includes a video streaming device, where the video streaming device can be a content server or a content delivery server, where the video streaming device is configured to obtain a bitstream from one of the storage mediums, and send the bitstream to a terminal device.

In one possible embodiment, an exemplary method for converting format of a bitstream is provided, the method includes: receiving a bitstream in a first format generated by any one of the encoding methods illustrated before; converting the bitstream in the first format into a bitstream in a second format; storing the bitstream in the second format in a storage medium.

Optionally, the method further includes sending the stored bitstream in the second format to a terminal-side apparatus in response to an access request of the terminal-side apparatus.

In one possible embodiment, an exemplary system for converting a bitstream format is provided, the system including a receiver configured to receive a bitstream in a first format generated by any one of the encoding methods illustrated before, and a processor configured to convert the bitstream in the first format into a bitstream in a second format, and the processor is further configured to store the bitstream in the second format into a storage medium, and the storage medium is configured to store the bitstream in the second format, and a transmitter configured to send the stored bitstream in the second format to a terminal-side apparatus in response to an access request of the terminal-side apparatus.

In one possible embodiment, an exemplary method for processing a bitstream is provided, the method includes: receiving a transport stream including a video stream and an audio stream, where the video stream is generated by any one of the encoding methods illustrated before, demultiplexing the transport stream to separate the video stream and the audio stream, decoding the video stream by using a video decoder to obtain video data, and decoding the audio stream by using an audio decoder to obtain audio data.

Optionally, the method further includes synchronizing the audio data and the video data and outputting the synchronization result to the player for playback.

Optionally, the method further includes decoding the bitstream to obtain video data or image data and performing at least one of luminance mapping, chroma mapping, resolution adjustment, or format conversion on the video data or image data, and sending the video data or image data to a display.

In one possible embodiment, an exemplary method for transmitting a bitstream based on an user operation request is provided, the method including: receiving a first operation request from an end-side apparatus, where the first operation request is used to request to play a target video; determining, in a storage medium in response to the first operation request, a bitstream corresponding to the target video, where the bitstream corresponding to the target video is a bitstream generated according to any one of the encoding methods illustrated before, and sending the target bitstream to the end-side apparatus.

Optionally, the method further includes encapsulating the bitstream to obtain a transport stream in a first format and sending the transport stream in the first format to a terminal-side apparatus for display or, sending the transport stream in the first format to storage space for storage.

In one possible embodiment, an exemplary system for transmitting a bitstream based on an user operation request is provided, the system including: a storage medium configured to store a bitstream, where the bitstream is a bitstream generated according to any one of the encoding methods illustrated before, a receiver, configured to receive a first operation request, and a processor configured to determine a target bitstream in the storage medium in response to the first operation request, and a transmitter configured to send the target bitstream to a terminal-side apparatus.

Optionally, the processor is further configured to: encapsulate the bitstream to obtain a transport stream in a first format, and the system further includes a transmitter configured to: send the transport stream in the first format to a terminal-side apparatus for display or send the transport stream in the first format to storage space for storage.

In one possible embodiment, an exemplary method for downloading a bitstream is provided, the method includes: obtaining a bitstream from a storage medium, where the bitstream is generated according to any one of the encoding methods illustrated before, and decoding the bitstream to obtain a streaming media file, dividing the streaming media file into multiple streaming media segments, and downloading the multiple streaming media segments separately.

In one possible embodiment, an exemplary system for downloading a bitstream is provided, the system includes an obtaining unit configured to obtain a bitstream from a storage medium, where the bitstream is generated according to any one of the encoding methods illustrated before, and a decoder configured to decode the bitstream to obtain a streaming media file; a processor, configured to divide the streaming media file into multiple streaming media segments where the processor is configured to download the multiple streaming media segments separately. However, the present disclosure is not limited to any of these exemplary implementations.

The present disclosure relates to methods and apparatuses for encoding data for still or video processing into a bitstream. The data are processed by a network which includes a gain unit. In the processing, feature maps are generated by encoder layers. Before quantizing, the feature map is processed by a gain unit, which further transforms the feature map with a target gain vector. The target gain vector corresponds to a first coding parameter, which is used to control the compression quality for images. A user can set different values for the first coding parameter to control different compression qualities for different images. A user can set different values for the first coding parameter to control different compression qualities for the luma samples and the chroma samples. The first coding parameter is encoded into the bitstream as well. With this approach, flexible processing which may operate on different bitstream size is provided. Accordingly, the data may be efficiently coded within the bitstream, depending on the first coding parameter which may vary depending on the content of the picture data coded.

The present disclosure further relates to methods and apparatuses for decoding data for still or video processing in a bitstream. The data are processed by a network which includes an inverse gain unit. In the processing, feature maps are generated by entropy decoder. Before further decoding, the feature map is processed by an inverse gain unit, which further transforms the feature map with a target inverse gain vector. The target inverse gain vector is obtained based on a first coding parameter, which may be parsed from the bitstream.

The present disclosure provides an efficient way for coding images or videos with different qualities and bitstream sizes, without training more models.

What is claimed is:

1. An apparatus, comprising:
one or more processors; and
a non-transitory computer-readable storage medium coupled to the one or more processors and configured to store instructions that, when executed by the one or more processors, cause the apparatus to:
obtain an image;
obtain a first coding parameter for the image, wherein a value of the first coding parameter is smaller than a preset minimal value or larger than a preset maximal value;
obtain a target gain vector based on the first coding parameter; and
encode, based on the target gain vector, the image.

2. The apparatus of claim 1, wherein the instructions, when executed by the one or more processors, further cause the apparatus to further obtain, when the value of the first coding parameter is smaller than the preset minimal value, the target gain vector based on the first coding parameter, the preset minimal value, and a first gain vector corresponding to the preset minimal value.

3. The apparatus of claim 2, wherein the instructions, when executed by the one or more processors, further cause the apparatus to:
obtain a first ratio of the first coding parameter to the preset minimal value; and
further obtain the target gain vector based on the first ratio and the first gain vector.

4. The apparatus of claim 3, wherein the instructions, when executed by the one or more processors, further cause the apparatus to further obtain the target gain vector by multiplying the first ratio and the first gain vector.

5. The apparatus of claim 2, wherein the target gain vector satisfies the following condition:
$${m}_{ν} = {m}_{s} * {( \frac{{β}_{ν}}{{β}_{s}} )}^{K} ,$$
wherein mᵥ is the target gain vector, βₛ is the preset minimal value, βᵥ is the first coding parameter, mₛ is the first gain vector, and K is a preset value.

6. The apparatus of claim 1, wherein the instructions, when executed by the one or more processors, further cause the apparatus to further obtain, when the value of the first coding parameter is larger than a preset maximal value, the target gain vector based on the first coding parameter, the preset maximal value, and a second gain vector corresponding to the preset maximal value.

7. The apparatus of claim 6, wherein the instructions, when executed by the one or more processors, further cause the apparatus to:
obtain a second ratio of the first coding parameter to the preset maximal value; and
further obtain the target gain vector based on the second ratio and the second gain vector.

8. The apparatus of claim 7, wherein the instructions, when executed by the one or more processors, further cause the apparatus to further obtain the target gain vector based on multiplying the second ratio and the second gain vector.

9. The apparatus of claim 6, wherein the target gain vector satisfies the following condition:
$${m}_{ν} = {m}_{t} * {( \frac{{β}_{ν}}{{β}_{t}} )}^{K} ,$$
wherein mᵥ is the target gain vector, βₜ is the preset maximal value, βᵥ is the first coding parameter, mₜ is the second gain vector, and K is a preset value.

10. The apparatus of claim 1, wherein the instructions, when executed by the one or more processors, further cause the apparatus to further obtain, when the value of the first coding parameter is smaller than the preset minimal value, the target gain vector based on the first coding parameter, the preset minimal value, a first gain vector corresponding to the preset minimal value, a third preset value which is nearest to the preset minimal value, and a third gain vector corresponding to the third preset value.

11. The apparatus of claim 1, wherein the instructions, when executed by the one or more processors, further cause the apparatus to further obtain, when the value of the first coding parameter is larger than a preset maximal value, the target gain vector based on the first coding parameter, the preset maximal value, a second gain vector corresponding to the preset maximal value, a fourth preset value which is nearest to the preset maximal value, and a fourth gain vector corresponding to the fourth preset value.

12. The apparatus of claim 1, wherein the instructions, when executed by the one or more processors, further cause the apparatus to further obtain the target gain vector based on the first coding parameter, N preset values, and N gain vectors corresponding to the N preset values, wherein N is an integer larger than 2, and wherein the N preset values include the preset minimal value and/or the preset maximal value.

13. The apparatus of claim 1, wherein the instructions, when executed by the one or more processors, further cause the apparatus to:
obtain a first feature map of the image using a neural network;
obtain a second feature map based on the first feature map and the target gain vector;
quantize the second feature map to obtain a quantized second feature map; and
encode the quantized second feature map to obtain a bitstream.

14. The apparatus of claim 13, wherein the instructions, when executed by the one or more processors, further cause the apparatus to obtain the second feature map by multiplying the target gain vector with the first feature map.

15. The apparatus of claim 13, wherein the first feature map is a tensor with a shape of w×h×d, wherein the target gain vector is a vector with dimension 1×d, wherein w and h represent the width and height of the first feature map, and wherein d represents a number of channels of the first feature map.

16. The apparatus of claim 15, wherein when the first feature map is of luma samples of the image, d equals to 128, or wherein when the first feature map is a feature map of chroma samples of the image, d equals to 64.

17. The apparatus of claim 1, wherein the instructions, when executed by the one or more processors, further cause the apparatus to:
obtain a second coding parameter for the image; and
use the second coding parameter to encode chroma samples of the image when the first coding parameter is used to encode luma samples of the image; or
use the second coding parameter to encode luma samples of the image when the first coding parameter is used to encode chroma samples of the image.

18. The apparatus of claim 1, wherein the instructions further cause the apparatus to encode the first coding parameter into a bitstream.

19. An image encoding method, comprising:
obtaining an image;
obtaining a first coding parameter for the image, wherein a value of the first coding parameter is smaller than a preset minimal value or larger than a preset maximal value;
obtaining a target gain vector based on the first coding parameter; and
encoding, based on the target gain vector, the image.

20. A non-transitory computer-readable storage medium storing an encoded bitstream that, when decoded, enables a coding device to:
generate a video comprising coded image data and a plurality of syntax elements,
wherein the plurality of syntax elements comprises a flag,
wherein the flag derives a value of a coding parameter indicating a compression quality of the coded image data, and
wherein the value of the coding parameter is smaller than a preset minimal value or larger than a preset maximal value.
